(19) United States
(12) Patent Application Publication
(10) Pub. No.: US 2011/0146889 A1
(43) Pub. Date: Jun. 23, 2011

(54) METHOD FOR MANUFACTURING DISPLAY DEVICE WITH OPTICAL/ELECTRONIC STRUCTURES

(75) Inventor: Jang Hwan Hwang, Gyeonggi-do (KR)

(73) Assignees: Jang Hwan HWANG, Goyang-si, Gyeonggi-do (KR); FINETEK, CO., LTD., Paju-si, Gyeonggi-do (KR)

(21) Appl. No.: 13/060,142

(22) PCT Filed: Sep. 30, 2009
(86) PCT No.: PCT/KR2009/005614

§ 371 Date: Feb. 22, 2011

(30) Foreign Application Priority Data
Oct. 1, 2008 (KR) 10-2008-0096604
Apr. 21, 2009 (KR) 10-2009-0034493
May 20, 2009 (KR) 10-2009-0043999
May 20, 2009 (KR) 10-2009-0044000
Jul. 9, 2009 (KR) 10-2009-0062396
Jul. 9, 2009 (KR) 10-2009-0062540

(51) Int. Cl. B32B 38/08; B32B 38/10; B32B 37/02; B32B 37/12; B32B 37/14

(52) U.S. Cl. 156/150; 156/247

(57) ABSTRACT

A disclosed method for manufacturing a display device with optical/electronic structures according to the present invention comprises: a first step for forming the optical/electronic structures on the primary side of a release film onto which an adhesive is applied, a second step for attaching the primary side of the release film to a substrate or a film, and a third step for removing only the release film from the substrate or film while the optical/electronic structures are attached thereto. According to the invention, the optical/electronic structures are transferred and attached to the substrate or film of the display device after firstly being attached to the release film. Therefore, the optical structure, such as a certain shaped micro lens, color filter, polarizing layer, or ITO layer, with optical characteristics or the electronic structure such as a circuit or electrode pattern like a thin film transistor (TFT) and in-cell phase difference film can be formed on the surface of the substrate or film very easily. That is to say, the optical/electronic structures can be formed very easily on the substrate or film of the display device in a desirable shape with uniform shape and size. In addition, the deterioration of an element of the display device can be prevented as a result of attaching the optical/electronic structures to the display device without directly radiating rays of light such as ultraviolet rays onto the display device.

### TECHNICAL FIELD

The present invention relates to a method of manufacturing a display device having optical/electronic structures. More particularly, the present invention relates to a method of manufacturing a display device, which facilitates to form optical structures such as a certain shaped micro lens, color filter, polarizing layer, or ITO layer, with optical characteristics, or electronic structures such as an electrode pattern or circuit like Thin Film Transistor (TFT), In-cell phase difference film onto a substrate or film by using a release film. Therefore, the present invention facilitates the process of manufacturing a display device with uniform pattern of the structures.

### BACKGROUND ART

Display devices in the information society are important media for transferring visual information, and are demanded to have many requirements such as characteristics of low power dissipation, slimming, lightweight, high definition.

For example, display devices, such as Liquid Crystal Device (LCD), Organic Light Emitting Diode (OLED), Plasma Display Panel (PDP) have been developed and used.

Liquid Crystal Device (LCD) is defined as a display device expressing information by using changes of a state of a liquid crystal and polarizing characteristic of a polarizing plate and controlling the amount of transmitted light. LCD comprises two glass substrates with color filter and TFT, a liquid crystal injected between two glass substrates, and a Back Light Unit (BLU) as a light source.

Color filter is formed by coating red pixels, green pixels, and blue pixels onto a glass substrate, which realizes color images. TFT is defined as a circuit forming a semiconductor film onto a glass substrate for controlling liquid crystal. The circuit can control each pixel as a basic unit of image respectively.

OLED is defined as a self-luminous typed display device using phenomena of forming an exciton by recombining an electron and a hole injected through anode and cathode to organic thin film and emitting light with a certain wavelength range.

The OLED is made by the processes of sputtering ITO metal onto a glass substrate, patterning an electrode in a desirable shape using photo-resist process, forming an anode electrode to image expression area, forming organic electric field light-emitting unit emitting light through flow of electric current by evaporating organic material with a certain chromophore, and forming a cathode electrode by sputtering a cathode forming metal, such as an electrode material like Al and Mg on the upper side of organic electric field light-emitting unit.

However, said display devices, such as LCD and OLED have many disadvantages of difficult processes, for example optical/electronic structures such as color filter or ITO electrode layer are made by several repetition of depositions, cleaning, PR coating, exposure, development, etching process, and difficulties of forming height and size of structure uniformly.

The display devices, such as LCD and OLED also cause many loss of light in the process in which a light emitted from a light source transmits a glass substrate and polarizing plate. Finally, the light supplied to an external user is much lesser than that emitted from the light source.

For solving the conventional problems, there are many attempts to diminish any light loss by forming micro lens having a certain shape, such as hemisphere shape onto a substrate or optical film and changing an angle of light transferring the substrate or optical film.

The method of forming micro lens onto a substrate of display device directly consists of setting a stamper in the external side of a substrate, supplying a resin for forming micro lens through the stamper, and hardening the micro lens by radiating UV.

However, as above described, there is a problem that organic material formed onto a substrate is deteriorated when UV is radiated to a micro lens formed onto the substrate following the formation of micro lens on the surface of a substrate by using the stamper.

The micro lens also can be formed on the surface of the substrate by using a method of forming the micro lens on the surface of conventional optical film to attach the film to the substrate. However, the above-described method has a problem that a light loss occurs due to total reflection in light emitting surface of the substrate incurred by the presence of air-gap between a side of the optical film and substrate.

As alternative for solving the problem, another researcher suggested a method of forming a micro lens on the surface of a substrate or film simultaneously when the substrate or the film is made by using injection molding. However, the conventional methods have very complicated and difficult problems.

### DISCLOSURE

### Technical Problem

An object of the present invention is to provide a method of manufacturing a display device with optical/electronic structures that enable to form optical structures such as a certain shaped micro lens, color filter, polarizing layer, or ITO layer, with optical characteristics for supplying specific optical characteristics, or electronic structures such as an electrode pattern or circuit like Thin Film Transistor (TFT), In-cell phase difference film on the surface of a substrate or film of a display device easily, and to obtain uniform pattern of the structures.

### Technical Solution

To solve the above-mentioned objects, a method of manufacturing a display device with optical/electronic structures according to the present invention comprises a first step for forming the optical/electronic structures on the primary side of a release film onto which an adhesive is attached; a second step for attaching the primary side of the release film to a substrate or a film; and a third step for removing only the release film from the substrate or the film while the optical/electronic structures are attached thereto.

Here, the first step is characterized that a resin is applied onto the primary side of a release film through a pattern groove by supplying the resin for forming the optical/electronic structures to a pattern roller, while the primary side of a release film passes with being pressed to an external side of the pattern roller which has the pattern corresponding with the optical/electronic structures.

The first step is also preferable to attach optical/electronic structures on a release film by spraying and hardening a resin for forming optical/electronic structures on the primary side of the release film.

The first step is preferable to form optical/electronic structures on the primary side of a release film, which are hardened following that the optical/electronic structures fall upon the primary side of the release film to inject a resin for the optical/electronic structures inside a cylinder-typed screen in which a number of minute holes are formed at certain distances with a fixed pressure.

The second step is preferable that when a release film is attached on a film, an adhesive having the higher refractive index than optical/electronic structures is applied on the primary side of a release film in advance, and the refractive index of the adhesive is 1.5 to 1.65.

It is also preferable that the optical/electronic structures having a form of hemisphere-shaped dome or polygon-shaped bump are a number of micro lenses altering the proceeding route of a light, and the refractive index of another adhesive being applied in the second step additionally is 1.5 to 1.65, which has the higher refractive index than micro lenses.

It is preferable that the optical/electronic structures consist of black matrix and color filter.

The method is preferable to comprise further steps of a step of applying a protective film on the upper side in which color filter and black matrix are formed following the first step; a step of applying an adhesive on the protective film; and a step of applying a polarization film on the adhesive.

The method is also preferable to comprise further step of transferring the protective film, the adhesive, and the polarization film which is applied on another release film following the third step upon black matrix and color filter of the substrate.

It is preferable that the first step comprises a step of supplying a resin for forming black matrix or color filter to a resin supply roller; a step of delivering the resin to a pattern groove of a pattern formation roller which rotates and is connected with the resin supply roller, while the resin supply roller rotates; a step of delivering the resin stored in the pattern groove to the external side of a blanket roller which rotates and is connected with the pattern formation roller, while the pattern formation roller rotates; a step of hardening a pattered resin by radiating ultraviolet (UV) to the blanket roller; and a step of forming black matrix and color filter to deliver the patterned resin to a side of the release film which passes between the blanket roller and a pressurization roller which rotates and is connected with the blanket roller, while the blanket roller rotates.

The first step is preferable to supply the resin for forming black matrix or color filter to a formation roller having a pattern corresponding with the black matrix or the color filter; deliver the resin stored in the formation roller to the release film consecutively while the release film proceeds with adhered on the external side of the formation roller by passing the release film between a couple of pressurization rollers connected with the both side of the formation roller, and the external side of the formation roller; and form black matrix and color filter on the release film continuously.

The second step is preferable to install the pressurization roller onto a side of the substrate which is connected with the pressurization roller and moves in one way horizontally, and be enable to pass the release film between the pressurization roller and the substrate to attach the black matrix and color filter applied on the release film to the substrate while the black matrix and color filter are pressurized by the pressurization roller.

The method also can comprise further steps of a step of forming ITO layer on the rear side of the substrate; and a step of forming an organic light emitting unit on the ITO layer.

The step of forming an organic light emitting unit on the ITO layer is preferable to comprise the organic light emitting unit having 3 sub-pixels which emit the light with red, green and blue wavelength per each pixel respectively, or having a pixel which emits at least one white light per separate pixel.

Here, It is preferable that the first step consists of a step of attaching TFT on a side of the first release film, a step of attaching the second release film on the side which the TFT of the first release film is attached thereto, and a step of transferring the TFT on the second release film to be separated from the first release film; the second step consists of a step of attaching the side of the second release film which the TFT is attached thereto upon the substrate; and the third step consists of a step of separating only the second release film from the substrate while the TFT is transferred on the substrate.

The step of attaching TFT on a side of the first release film is preferable to layer TFT structures with designed pattern in consecutive order while the first release film passes a number of printing rollers which supply different resins for TFT on the side of the printing rollers separately.

The step of attaching the side of the second release film which the TFT is attached thereto upon the substrate is preferable that the second release film is pressurized against the substrate in a side of the substrate by using the pressurization roller to transfer the TFT on the substrate.

The optical/electronic structures are preferable to be thin film layers, form the thin film layer on a side of the release film by using printing method in the first step, proceed the step sputtering ITO layer on the side of substrate or film following the first step, transfer the thin film layer of the release film on the ITO layer through the third step, and the thin film layer is an organic thin film layer forming organic light emitting diode (OLED) or polymer light emitting diode (PLED).

The method is preferable to execute a heat or UV hardening process to increase an adhesive strength of interface among the separate thin film layers, and to transfer and layer thin film layers on the film consecutively while the films and release films pass a number of pressurization rollers rotating with constantly separated distance one another following the second step and the third step.

The optical/electronic structures are preferable to be in-cell phase difference films, the first step consists of a step of attaching the in-cell phase difference film on a side of the release film, the second step consists of a step of attaching the side of the release film on which the in-cell phase difference film is attached upon the substrate or the color filter formed on the substrate, and the third step consists of a step of separating only the second release film from the substrate while the in-cell phase difference film is transferred on the substrate or the color filter formed on the substrate.

The method is preferable to comprise further step of forming ITO layer on the in-cell phase difference film of the release film, and the first step is preferable to attach the in-cell phase difference film on the release film while the release film and the in-cell phase difference film pass through a number of rollers being contiguous each other at a time, and is pressurized.

It is preferable that the optical/electronic structures are preferable to be light path conversion means, the first step consists of a step of attaching the light path conversion means on the release film, the second step consists of a step of attaching a polarization film on the side on which the light path conversion means of the release film are attached, the third step consists of a step of attaching the polarization film and the light path conversion means on the substrate while the release film is separated from the complex of the polarization film and the release film, and the first step consists of a step of attaching at least one lens pattern on the release film, and a step of applying an adhesive on the side of the release film which the lens pattern is attached thereto.

It is preferable that the step of attaching at least one lens pattern on the release film of the first step comprises a step of supplying a resin for forming lens pattern to a resin supply roller; a step of delivering the resin for forming lens pattern to a pattern groove of a pattern formation roller which rotates and is connected with the resin supply roller, while the resin supply roller rotates; a step of delivering the resin for forming lens pattern stored in the pattern groove to the external side of a blanket roller which rotates and is connected with the pattern formation roller, while the pattern formation roller rotates; and a step of forming black matrix and color filter to deliver the patterned resin for forming lens pattern to a side of the release film which passes between the blanket roller and a pressurization roller which rotates and is connected with the blanket roller, while the blanket roller rotates.

It is preferable that the step of attaching at least one lens pattern on the release film of the first step comprises a step of supplying a resin for forming lens pattern to a formation roller on which a number of patterns are formed with patterns corresponding with lens patterns; a step of passing the release film with adhered on the external side of the formation roller; a step of radiating UV while the release film is proceeded with adhered on the external side of the formation roller to harden the resin for forming lens pattern stored in the pattern groove of the formation roller, and a step of separating the resin for forming lens pattern from the pattern groove and attaching the resin for forming lens pattern to the release film when the release film is separated from the formation roller.

It is preferable that the first step comprises a step of applying the first adhesive layer as to form at least one lens pattern with bump-shaped on the release film, and a step of applying the second adhesive layer with the lower reflective index than the first adhesive layer among lens patterns of the first adhesive layer; the said second step comprises a step of passing through at least one pressurization roller rotating with constantly separated distance between the release film and the polarization film to attach the release film and the polarization film each other; and comprises further step of executing a height compensation of the lens pattern in order to solve an optical fault of view.

A method of manufacturing a display device with optical/electronic structures according to the present invention is preferable to comprise a first step for attaching optical/electronic structures on the primary side of a release film on which an adhesive is applied; a second step for applying another adhesive on the primary side of the release film on which the optical/electronic structures are attached; a third step for applying and hardening a resin for giving optical and electronic characteristics on the primary side of the release film to form a base film; a fourth step for separating only the release film form the base film; and a fifth step for attaching the base film upon the substrate or another film of display devices.

It is preferable that the optical/electronic structures have a form of hemisphere-shaped dome or polygon-shaped bump, and are a number of micro lenses altering the proceeding route of a light; and the another adhesive of the second step is 1.5 to 1.65, which has the higher refractive index than the micro lenses.

### Advantageous Effects

According to the invention, the optical/electronic structures are transferred and attached to the substrate or film of the display device after firstly being attached to the release film. Therefore, the optical structure, such as a certain shaped micro lens, color filter, polarizing layer, or ITO layer, with optical characteristics or the electronic structure such as a circuit or electrode pattern like a thin film transistor (TFT) and in-cell phase difference film can be formed on the surface of the substrate or film very easily. That is to say, the optical/electronic structures can be formed very easily on the substrate or film of the display device in a desirable shape with uniform shape and size. The present invention also has further advantage that the deterioration of an element of the display device can be prevented as a result of attaching the optical/electronic structures to the display device without directly radiating rays of light such as ultraviolet rays onto the display device.

### DESCRIPTION OF DRAWINGS

FIG. 1 is a flow chart explaining a method of manufacturing a display device with optical/electronic structures according to the present invention.

FIG. 2 is a schematic view illustrating the method of FIG. 1.

FIG. 3 as a practical example of a method for manufacturing a display device according to the present invention, is a schematic view illustrating a method of forming an optical structure on the both side of a light guide plate.

FIG. 4 as a modified example of FIG. 3, is a schematic view illustrating a method of forming an optical structure on the both side of a light guide plate with an identical direction.

FIG. 5 as another practical example of a method of manufacturing a display device according to the present invention, is a schematic view illustrating a method of forming an optical structure on the light emitting surface of OLED substrate directly.

FIG. 6 is a schematic view illustrating a modified example of FIG. 5.

FIG. 7 is a schematic view illustrating one example of composition of LCD realized from a method for manufacturing a display device according to the present invention.

FIG. 8 is a flow chart illustrating one example of a method for manufacturing LCD of FIG. 7.

FIG. 9 is a schematic view illustrating one example of forming a black matrix and color filter onto a release film in a method for manufacturing LCD of FIG. 7.

FIG. 10 is a schematic view illustrating another example of forming a black matrix and color filter onto a release film in a method for manufacturing LCD of FIG. 7.

FIG. 11 is a schematic view illustrating a further example of forming a black matrix and color filter onto a release film in a method for manufacturing LCD of FIG. 7.

FIG. 12 is a schematic view illustrating another example of transferring a black matrix and color filter formed on a release film to a substrate in a method for manufacturing LCD of FIG. 7.

FIG. 13 is a sectional view illustrating one example of composition of OLED realized from a method for manufacturing a display device according to the present invention.

FIG. 14 is a sectional view illustrating another example of composition of OLED realized from a method for manufacturing a display device according to the present invention.

FIG. 15 is a schematic view illustrating composition of a general LCD device.

FIG. 16 is a sectional view illustrating one example of TFT structure of LCD device in FIG. 15.

FIG. 17 is a flow chart illustrating a method of manufacturing TFT of LCD device according to the present invention.

FIG. 18 is a schematic view illustrating a practical example of an apparatus forming TFT on a release film in a method of manufacturing TFT of LCD device according to the present invention.

FIG. 19 is a sectional view illustrating a partial composition in an apparatus of FIG. 18 in detail.

FIG. 20 is a sectional view illustrating another practical example of a TFT structure of LCD device.

FIG. 21 is a schematic view illustrating a practical example of an apparatus composition for forming TFT of FIG. 20 on a release film.

FIG. 22 is a sectional view illustrating a state of attaching another release film to the release film on which TFT is formed.

FIG. 23 is a sectional view illustrating a practical example of a process transferring TFT of a release film to a substrate.

FIG. 24 is a flow chart illustrating a method of manufacturing display device according to the present invention.

FIG. 25 is a sectional view illustrating a composition of PLED.

FIG. 26 as a practical example of a method for manufacturing PLED according to the present invention, is a schematic view illustrating an apparatus for forming organic thin film layer on a release film.

FIG. 27 as a practical example of a method for manufacturing PLED according to the present invention, is a schematic view illustrating an apparatus for transferring the organic thin film layer applied on a release film to an electrode film.

FIG. 28 is a sectional view illustrating an example of a composition of a general in-cell typed LCD device.

FIG. 29 is a flow chart explaining a method of manufacturing in-cell typed LCD device according to the present invention.

FIG. 30 is a schematic view illustrating a practical example of a stage of attaching an in-cell phase difference film on a release film in a method of manufacturing in-cell typed LCD device according to the present invention.

FIG. 31 is a schematic view illustrating a practical example of a stage of coating ITO layer onto an in-cell phase difference film of a release film in a method of manufacturing in-cell typed LCD device according to the present invention.

FIG. 32 is a schematic view illustrating a practical example of a stage of attaching another release film onto an in-cell phase difference film of a release film and ITO layer in a method of manufacturing in-cell typed LCD device according to the present invention.

FIG. 33 is a schematic view illustrating a practical example of a stage of transferring an in-cell phase difference film of a release film and ITO layer to a color filter of a substrate in a method of manufacturing in-cell typed LCD device according to the present invention.

FIG. 34 is a sectional view illustrating a practical example of subject composition of a display device according to the present invention.

FIG. 35 is a flow chart illustrating a practical example of a method manufacturing the display device illustrated in FIG. 34.

FIG. 36 is a schematic view illustrating a practical example of a method attaching a lens pattern to a release film in a method of manufacturing display device of FIG. 35.

FIG. 37 is a schematic view illustrating another practical example of a method attaching a lens pattern to a release film in a method of manufacturing display device of FIG. 35.

FIG. 38 is a schematic view illustrating a practical example of a method attaching a release film to a polarizing film, and the polarizing film to a glass substrate.

FIG. 39 is a sectional view illustrating another practical example of a display device according to the present invention.

FIG. 40 is a flow chart illustrating another practical example of a method manufacturing the display device illustrated in FIG. 34.

FIG. 41 is a sectional view illustrating a structure of the display device with optical structures.

FIG. 42 is a schematic view illustrating a practical example of a method manufacturing the display device of FIG. 41.

### BEST MODE

The above-described objects, characteristics and other advantages of the invention may be better understood by reference to the following examples which are intended for the purpose of illustration. Hereinafter, the examples of a method of manufacturing a display device with optical/electronic structures according to the present invention will be explained with referring attached figures.

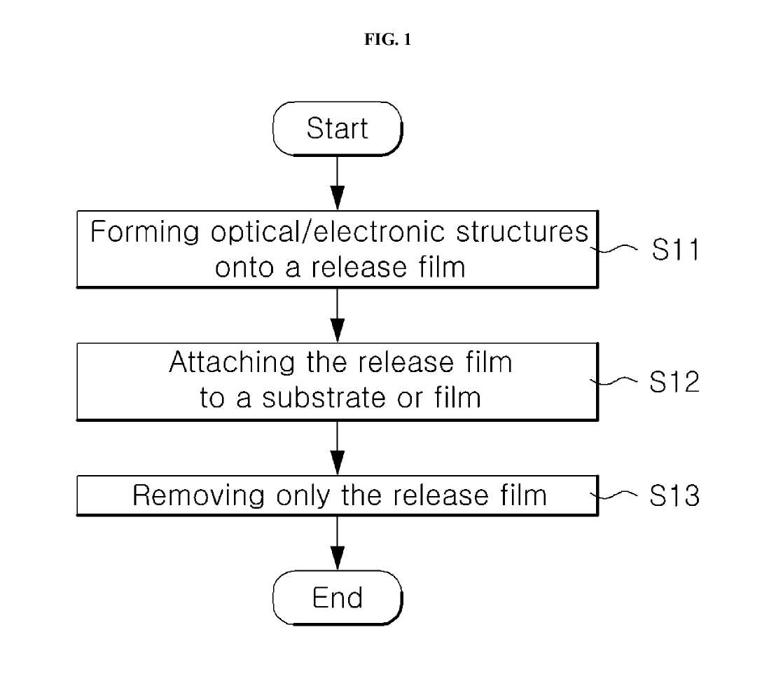

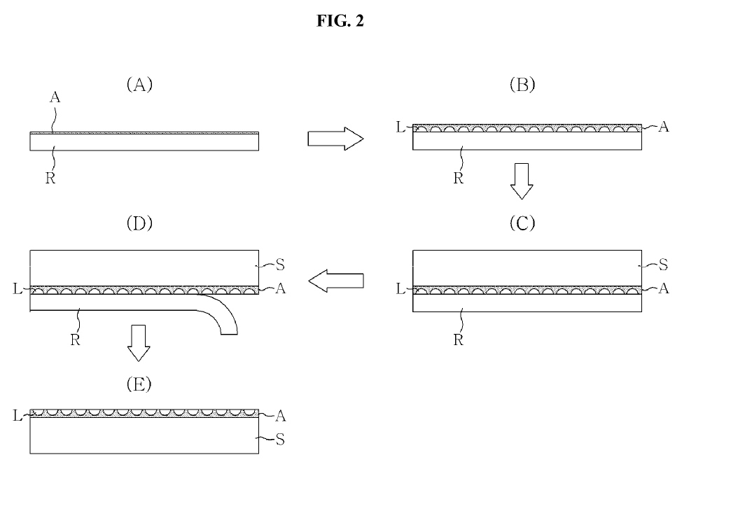

FIG. 1 and FIG. 2 are the figures explaining the first example of a method manufacturing the display device. The method of manufacturing the display device according to the example is comprised of a first step S11 for forming the optical/electronic structures L on an adhesive layer A of the primary side of a release film R onto which an adhesive is attached; a second step S12 for attaching the adhesive layer A of the primary side of a release film R to a substrate S or a film; and a third step S13 for removing only the release film R from the substrate S or the film while the optical/electronic structures are attached thereto.

FIGS. 2(A) and (B) illustrate the step S11, (C) of FIG. 2 illustrates the step S12, and (D), and (E) of FIG. 2 illustrate the step S13 roughly.

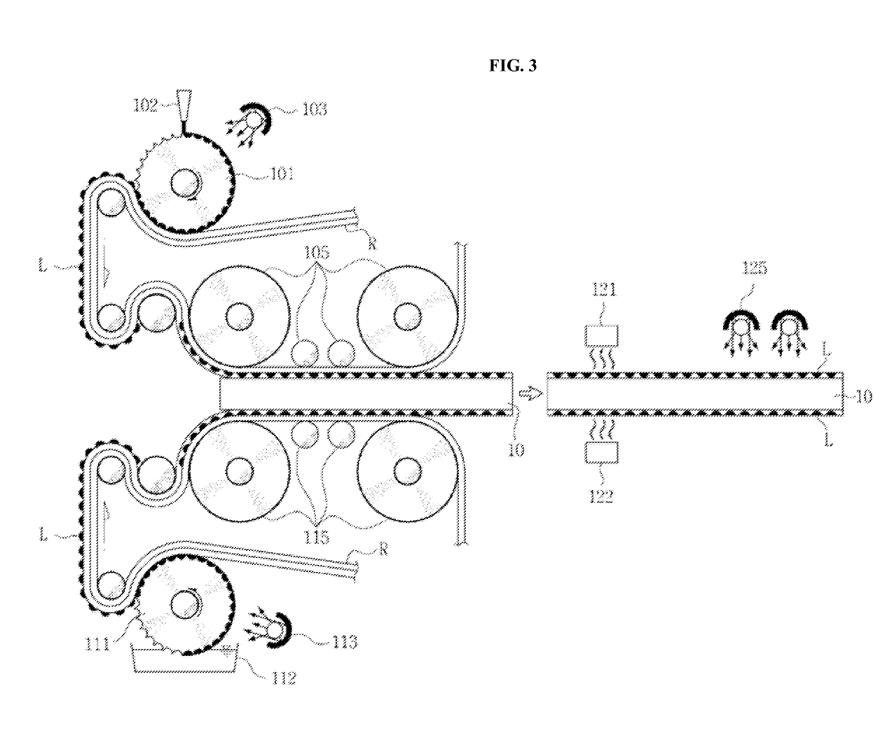

FIG. 3 illustrates a method of forming micro lens L as an optical structure on the both side of a light guide plate more concretely according to the first example.

Referring to FIG. 3, an upper formation roller 101 being able to rotate is installed on the upper side of the light guide plate 10 which is installed as to move horizontally by a transfer apparatus (not illustrated) such as conveyor system, and a number of upper press rollers (105) being able to rotate are installed on the upper side of the light guide plate 10 for pressurizing a side on which an adhesive is applied in a release film R against on the upper side of the light guide plate 10. Resin feeder 102 which supplies a resin for forming micro lens in a formation groove of outer side of an upper formation roller 101, is installed to one side of the upper formation roller 101, and UV hardening apparatus 103 which hardens a resin for forming micro lens stored in a formation groove of an upper formation roller 101, is installed to the other side of the upper formation roller 101.

A lower formation roller 111, lower press roller 115, resin supplier 112, and UV hardening apparatus are installed to a lower side of the light guide plate 10 as the upper side of the light guide plate 10.

Although not mentioned in the FIG., a supply roller in which a release film R is wound for supplying to an upper formation roller 101 and a lower formation roller 111, and a collection roller in which the release film R separated through the light guide plate 10 is collected are installed in the upper and lower side of moving path of the light guide plate 10 respectively.

An upper and lower heating apparatus 121, 122 which heat toward the light guide plate 10, and an UV hardening apparatus 125 which radiates UV toward the light guide plate 10 are installed in rear side of the upper and lower press roller 105, 115 in order.

Hereinafter, a process of forming micro lens L in both side of the light guide plate 10 by using the above-mentioned apparatus will be explained in detail.

A release film R which got loose from a supply roller (not illustrated) passes with being adhered beneath the outer side of an upper formation roller 101. At this time, a resin for forming micro lens is supplied from the upper side of an upper formation roller 101 through a resin supplier 102. After the supplied resin is stored in hemispheric dome-shaped formation groove which is formed on the outer side of the upper formation roller 101 and is hardened by ultraviolet which is radiated from an UV hardening apparatus 103, the supplied resin is transferred to the side which an adhesive of the release film R is applied while being adhered beneath the side which an adhesive of the release film R.

The release film R of which a micro lens L is adhered in one side passes between upper formation roller 105 and light guide plate 10 while passing the upper formation roller 101. At this time, a release film R is pressurized by the upper press roller 105, and adhesive application layer of the release film R is adhered on the upper side.

The release film R which passed the upper press roller 105 is wound to the collection roller (not illustrated). At this time, because an adhesive application layer of a release film R on which micro lens L is formed is adhered on the upper side, the release film is only separated, and the adhesive application layer on which the micro lens is adhered remains in the light guide plate as it is.

The adhesive application layer on which the micro lens is formed is also adhered beneath the light guide plate 10 by the lower formation roller 111 and the lower press roller 115 in the identical method with the above-described process.

As above-described, the light guide plate 10 of which the micro lens is formed on the upper and lower side passes the upper and lower heating apparatus 121, 122, and UV hardening apparatus 125 which is arranged in the rear one after another, and is adhered on the side of the light guide plate 10 stably.

The light guide plate 10 of which the micro lens L is formed on the upper and lower side is made by the above-described processes. Although the micro lens L having hemispheric dome-shaped formation as an optical structure is formed on the upper and lower side of the light guide plate 10 in this example, the optical structure only can be formed on one side of the light guide plate 10, or optical structures having a different size and shape such as micro lens and prism pattern can be formed on the upper side and lower side of the light guide plate 10 respectively.

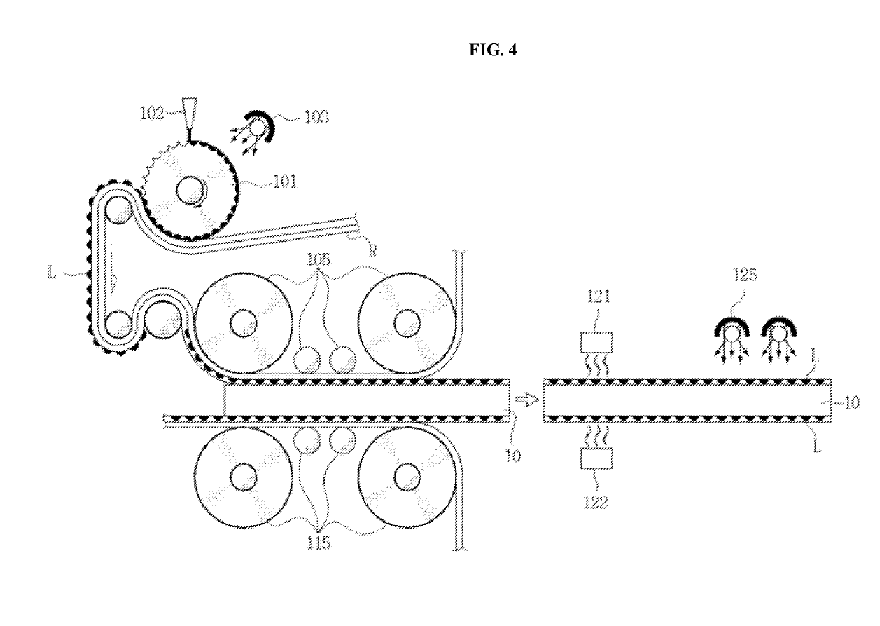

Although in the above-described example, micro lenses L were formed on the upper and lower sides of the light guide plate 10 in reverse direction each other, as illustrated in FIG. 4, the micro lenses in the upper and lower side of the light guide plate 10 can be arranged in identical direction by altering the constitution and arrangement of a formation roller properly to supply the release film R which is supplied to the lower side of the light guide plate 10 in reverse direction. The opposite method also will be possible.

Optical structures can be formed on a substrate or film of another display devices in the same as the identical method forming optical structures on the light guide plate 10 explained in above-described example.

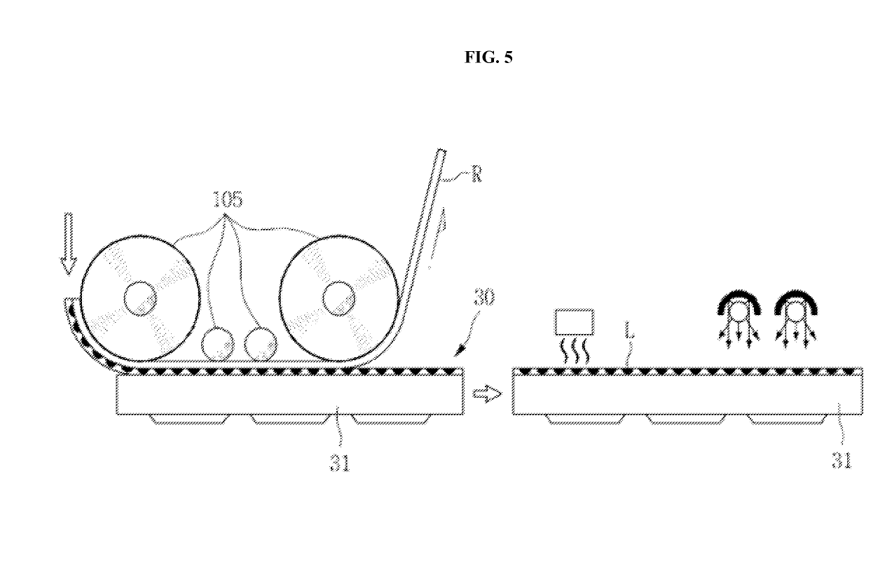

For example, as illustrated in FIG. 5, after forming the optical structure such as micro lens L on an adhesive application layer of a release film R, OLED 30 of which micro lens L is formed in light emitting surface can be realized by separating the release film R after adhering the adhesive application layer of the release film R in the light emitting surface of the substrate 31 of OLED 30.

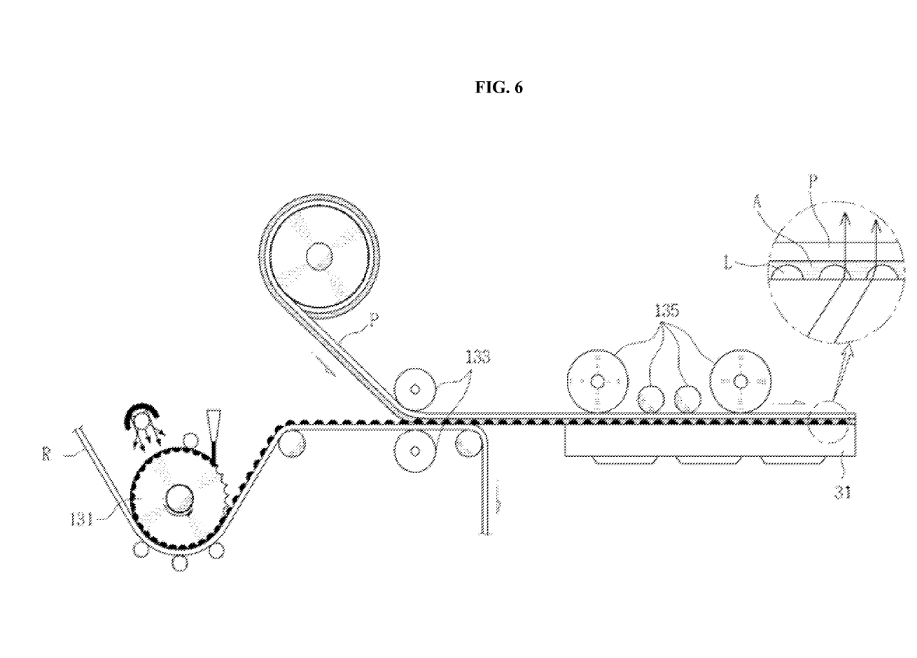

As illustrated in FIG. 6, optical structures such as micro lens L are formed on the adhesive application layer of the release film R, and after the micro lens L is transferred and adhered to polarization film P, the polarization film P on which the micro lens L is adhered can be adhered on the surface of the substrate 31 of OLED 30.

That is, after the micro lens L is formed on one side of the release film R by the lens formation roller 131, the release film R and the polarization film on which an adhesive is applied in one side pass through adhesion roller 133 to adhere the polarization film P and release film R. Afterwards, when the release film R is separated from the polarization film P, the micro lens L which was adhered on the release film R is transferred and adhered on the surface of which an adhesive of the polarization film P is applied. The polarization film P is supplied to the light emitting surface of the substrate 31 of OLED 30 with the state in which micro lens L is adhered in one side, and is adhered on the light emitting surface of the substrate 31 of OLED 30 by a press roller 135.

At this time, with respect to the adhesive A and micro lens L applied on one side of the polarization film P, it is preferable that the micro lens L consists of the resin with the higher refractive index than that of the substrate 31, and the adhesive A consists of the resin having the higher refractive index of 1.5˜1.65 than that of the micro lens L so as to increase a light extraction efficiency.

Although the micro lens L is formed to the polarization film P in this example to adhere to OLED 30, it will be able to use a protective film or other different optical film instead of the polarization film P.

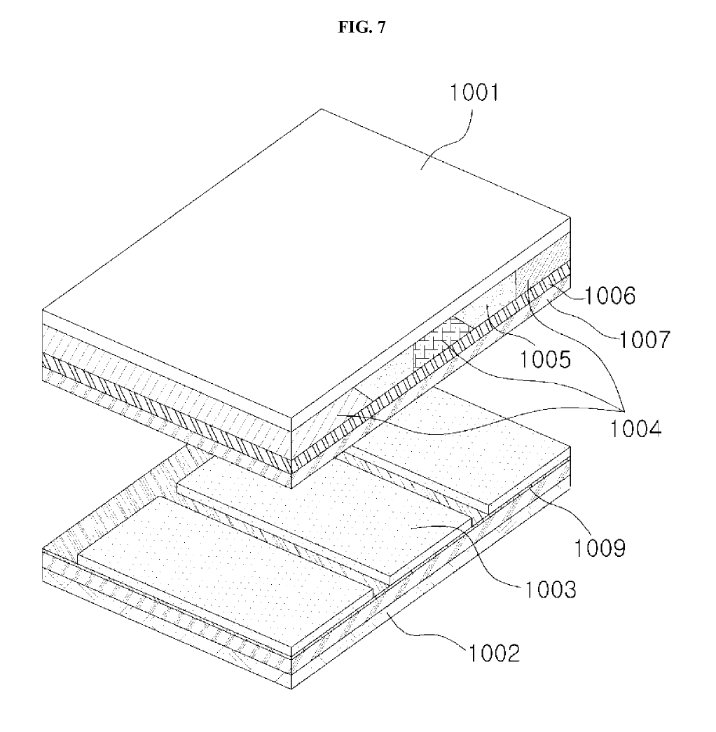

Then, referring FIG. 7 to FIG. 14, an example for method of manufacturing LCD will be explained as a example of display device according to the present invention.

Referring FIG. 7, an example of the constitution of LCD is explained.

LCD consists of an upper substrate 1001 and a lower substrate 1002. Black matrix 1004 and color filter 1005 are formed beneath the upper substrate 1001 by method of manufacturing display device of the present invention, and SiO₂ protection layer 1006 and ITO layer 1007 are laminated beneath the color filter 1005 in order. ITO layer 1009 and TFT layer 1003 are formed on the lower substrate 1002 on after another. Liquid crystal is injected between the upper substrate 1001 and the lower substrate 1002.

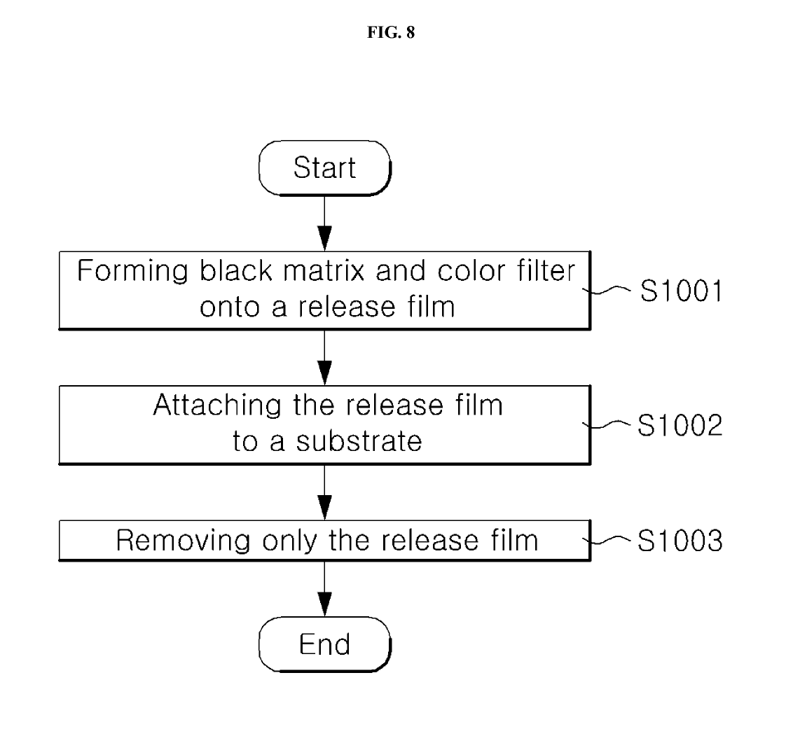

Then, referring FIG. 8 to FIG. 12, an example for method of manufacturing LCD with the above-described structures will be explained in detail.

As illustrated in FIG. 8, the method of manufacturing display device according to the present invention approximately consists of the first step forming black matrix and color filter on a side of release film in order 51001, the second step adhering the surface on which the black matrix and color filter of the release film are formed to the substrate S 1002, and the third step separating the only release film from the substrate while the black matrix and color filter are transferred on the substrate S 1003.

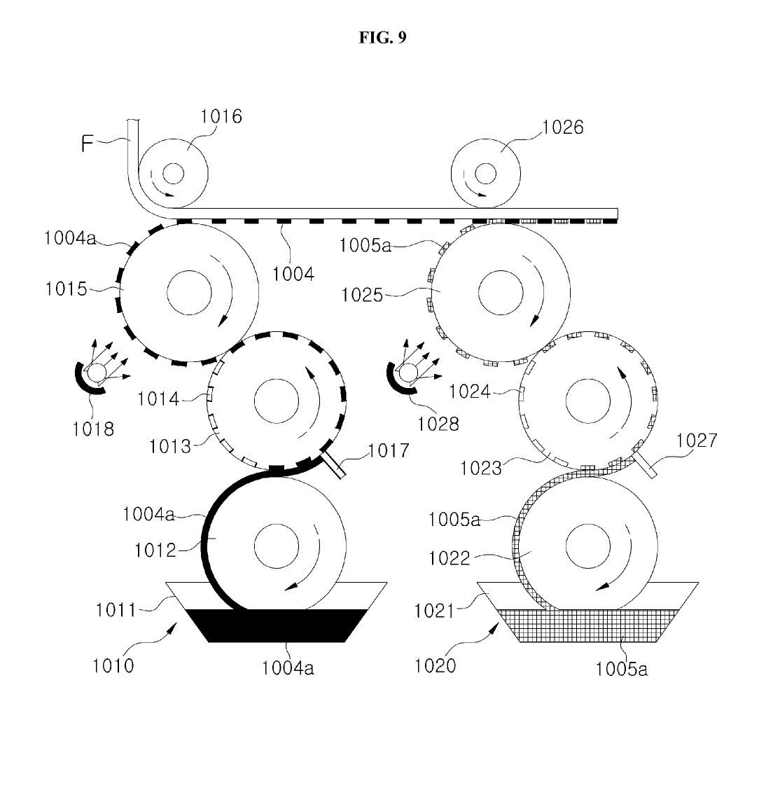

The first step S1001 can comprise by using black matrix formation apparatus 1010 and color filter formation apparatus 1020 which have the method of mixing off-set technology and roller scribing technology as illustrated in FIG. 9.

More particularly, black matrix formation apparatus 1010 for forming the black matrix 1004 on the release film F comprises a resin supply part 1011 in which resin for black matrix 1004a is stored, a resin supply roller 1012 which is installed over the resin supply part 1011 so as to be rotatable and of which an external surface of lower part is filled with the resin for black matrix 1004a stored in the resin supply part 1011, a pattern formation roller 1013 which is installed so as to be connected over the resin supply roller 1012 and of which pattern grooves 1014 of the pattern corresponding with the black matrix 1004 are formed in the external surface to receive the resin from the external surface of the resin supply roller 1012 to the inner side of the pattern groove 1014, a blanket roller 1015 installed so as to be connected over the pattern formation roller 1013 to receive the resin from the pattern groove 1014 of pattern formation roller 1013, and a pressurization roller 1016 installed so as to be connected over the blanket roller 1015 to adhere the black matrix resin to the release film F by pressurizing the release film F which passes the external surface of the blanker roller 1015 against the blanket roller 1015.

A scriber 1017 which rakes out a resin applied in the external surface of the pattern formation roller 1013 is installed for the resin not to remain in the surface besides the pattern groove 1014, and UV hardening apparatus 1018 which radiates UV to the external surface of the blanket roller 1015 to harden the black matrix resin 1004a is installed to one side of the blanket roller 1015.

A color filter formation apparatus 1020 for forming color filter 1005 on the release film F comprises a resin supply part 1021 in which one resin for color filter 1005a of R, G, B color filters is stored in the same way as black matrix formation apparatus 1010, a resin supply roller 1022, a pattern formation roller 1023, a blanket roller 1025, a pressurization roller 1026, a scriber 1027, and UV hardening apparatus 1028. Although only one color filter formation apparatus 1020 is illustrated in the figure, two different color filter formation apparatuses are constituted with the same way in one side of the color filter formation apparatus 1020 to form the color filters in one side of the release film F successively.

The following explanation is regarding processes that black matrix 1004 is formed on the release film F by the black matrix formation apparatus 1010 constituted as the above-described.

A resin for black matrix 1004a of resin supply part 1011 is applied on the external surface of a resin supply roller 1012 when the resin supply roller 1012 rotates. At this time, the pattern formation roller 1013 receives the black matrix resin 1004a applied on the resin supply roller 1012 while the pattern formation roller 1013 rotates with rotating in reverse direction with the resin supply roller 1012.

The resin which was applied outside the pattern groove 1014 is removed, and only the resin which is stored inside the pattern groove 1014 while the black matrix resin 1004a transferred to the pattern formation roller 1013 passes a scriber 1017.

A resin for black matrix 1004a which was stored inside the pattern groove 1014 of the pattern formation roller 1013 is transferred to the external surface of the blanket roller 1015 of which surface energy is higher than that of the pattern formation roller 1013 in parts connected with the blanket roller 1015.

The resin for black matrix 1004a which was transferred to the blanket roller 1015 is hardened by UV hardening apparatus 1018 to have a certain viscosity, and the resin is adhered on one side of the release film F which passes between a pressurization roller 1016 and blanket roller 1015.

The color filter 1005 is formed in designated position by the identical process with above-described, while the release film F passes between a blanket roller 1025 and pressurization roller 1026 of the color filter formation apparatus 1020.

As above-described, when a black matrix 1004 and color filter 1005 are applied on the release film F by the method mixing offset technology and roller scribing technology, there is an advantage that printing has a precise pattern.

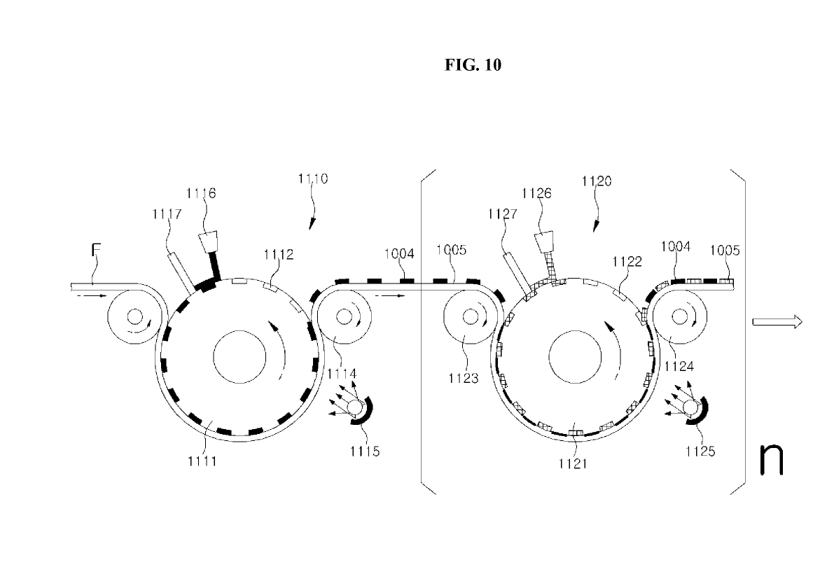

Besides the above-described method, a black matrix 1004 and color filter 1005 are formed on the release film F successively by using a black matrix formation apparatus 1110 and color filter formation apparatus 1120 to which roll-printing method is applied as illustrated in FIG. 10.

The black matrix formation apparatus 1110 illustrated in FIG. 10 comprises a formation roller 1111 in which a pattern groove 1112 of the pattern corresponding with a black matrix 1004 is formed, a resin supply part 1116 which supplies a resin for black matrix 1004a from the upper side of the formation roller 1111, a couple of pressurization rollers 1113, 1114 installed to be connected in both side of the formation roller 1111, a scriber 1117 raking the resin which is applied on the external surface of the formation roller 1111 to make the resin remained in only the formation groove 1112 of the formation roller 1111, and UV hardening apparatus 1115 radiating UV to harden the resin in one side of the formation roller 1111.

A color filter formation apparatus 1120 is constituted in one side of the black matrix formation apparatus 1110 to form a color filter 1005 on the release film F, and the color filter formation apparatus 1120 comprises a formation roller 1121 which a formation groove 1122 corresponding with a color filter pattern is formed in identical way with a black matrix formation apparatus 1110, a pressurization roller 1123, 1124, UV hardening apparatus 1125, a resin supply part 1126, and a scriber 1127. Though only one color filter formation apparatus 1120 is illustrated in FIG. 10, color filter formation apparatuses with the number of n can be constituted in one side of the color filter formation apparatus 1120. Here, n as a constant does not have any limitation. However, it is preferable to be constituted as 3 to 5. For example, the color filter formation apparatuses with the number of n can be constituted as follows; the case in which n is 3 will be Red, Green, and Blue, 4 will be Red, Green, Blue, and Yellow, and 5 will be Red, Green, Blue, Yellow, and White. Therefore, the color filter formation apparatuses 1120 are constituted with different colors of the number of n to be able to form color filters in one side of the release film F successively.

By using the black matrix formation apparatus 1110 and color filter formation apparatus 1120 which are constituted as the above-described, the process which forms a black matrix 1004 and color filter 1005 on the release film F is as follows:

As illustrated in FIG. 10, a resin for black matrix 1004a is supplied on the external surface of a formation roller 1111 which rotates in the upper side of a formation roller 1111 of the black matrix formation apparatus 1110 with one direction, in state in which a release film F passes between a formation roller 1111 and a pressurization roller 1113, 1114 with adhered to the formation roller 1111.

The resin for black matrix which was supplied on the external surface of the formation roller 1111 remains only inside the formation groove 1112 with raked by the scriber 1117. The resin for black matrix 1004a stored inside the formation groove 1112 of the formation roller 1111 is transferred and adhered in the site in which the release film F is separated from the formation roller 1111, and the black matrix 1004 is formed on the release film F with the constant pattern.

As above-described, the release film F on which the black matrix 1004 pattern is applied moves to the color filter formation apparatus 1120 of one side, and one color filter 1005 of R, G, B, Y, and W is applied on the release film F with wanted pattern and identical process with the black matrix formation apparatus 1110.

Afterwards, the color filter 1005 with different color is applied with wanted pattern while passing different color filter formation apparatus which is not illustrated in figure.

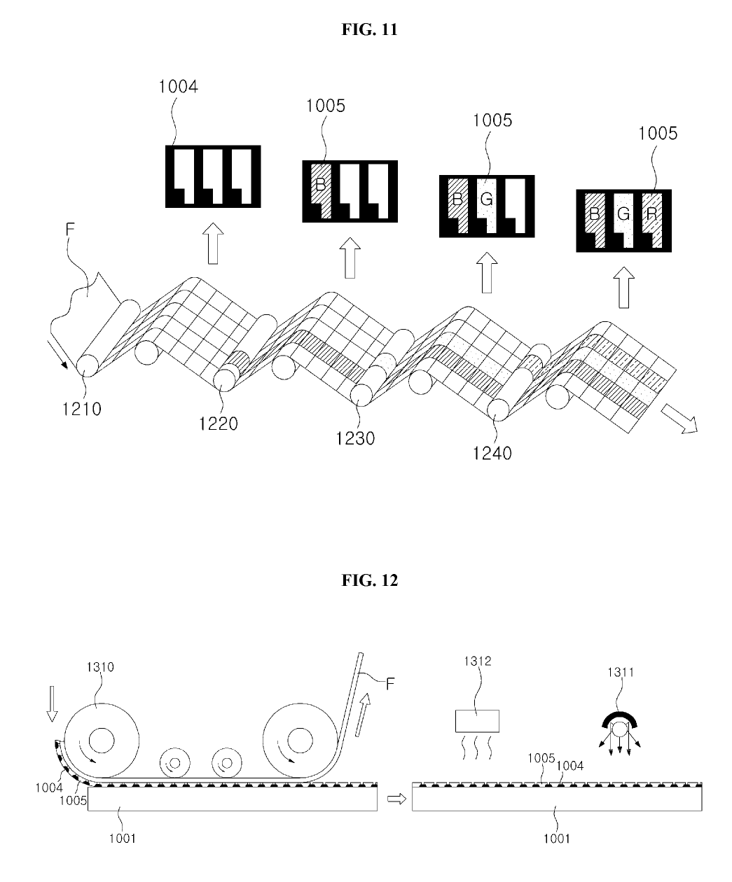

FIG. 11 is to illustrate another method forming a black matrix 1004 and color filter 1005 on a release film F. the black matrix formation apparatus and color filter formation apparatus according to the example makes the first formation roller 1210 for forming black matrix 1004, the second formation roller 1220 for forming color filter 1005 affiliated with blue, the third formation roller 1230 for forming color filter 1005 affiliated with green, and the fourth formation roller 1240 for forming color filter 1005 affiliated with red passed successively to form the black matrix 1004, blue color filter, green color filter, and red color filter on an adhesive application layer of the release film F one after another.

A formation groove (not illustrated) with the shape corresponding with black matrix and color filter pattern which will be formed respectively is formed on the external surface of the first formation roller to the fourth formation roller 1210˜1240 and, the resin for black matrix and the resins for color filter are supplied to be adhered on one side of release film F.

When the black matrix 1004 and color filters 1005 are formed on the release film F by choosing one of the methods explained as referring FIG. 9 to FIG. 11, the black matrix 1004 and color filter 1005 of the release film F are transferred on the substrate.

For example, as illustrated in FIG. 12, after the substrate 1001 is constituted to move to one direction horizontally, a number of pressurization rollers 1310 are constituted in the upper side of the substrate 1001, and the release film F is pressurized by a pressurization roller 1310 while passing between the substrate 1001 and pressurization roller 1310 so that the black matrix 1004 and color filter 1005 of the release film F are transferred on the surface of the substrate 1001 while the release film F is pressurized by the pressurization roller 1310, the release film F is separated to layer the black matrix 1004 and color filter 1005 on the substrate 1001.

It is preferable that the substrate 1001 is radiated by UV of UV hardening apparatus 1311 and/or heated by a heating apparatus 1312 to advance interface adhesive strength between black matrix 1004 and color filter 1005, and substrate 1001 after black matrix 1004 and color filter 1005 are laminated on the surface of the substrate 1001 as above-described.

According to the present invention, after the black matrix 1004 and color filter 1005 are formed on the release film F with the precise pattern, the black matrix 1004 and color filter 1005 are formed on the surface of the substrate 1001 by transferring and adhering the black matrix 1004 and color filter 1005 which are formed on the release film F on the surface of the substrate 1001 of LCD. Therefore, the process by which the black matrix 1004 and color filter 1005 are formed on the surface of the substrate 1001 becomes very simple, and the black matrix 1004 and color filter 1005 can be formed on the surface of the substrate 1001 with the precise pattern to realize high quality LCD.

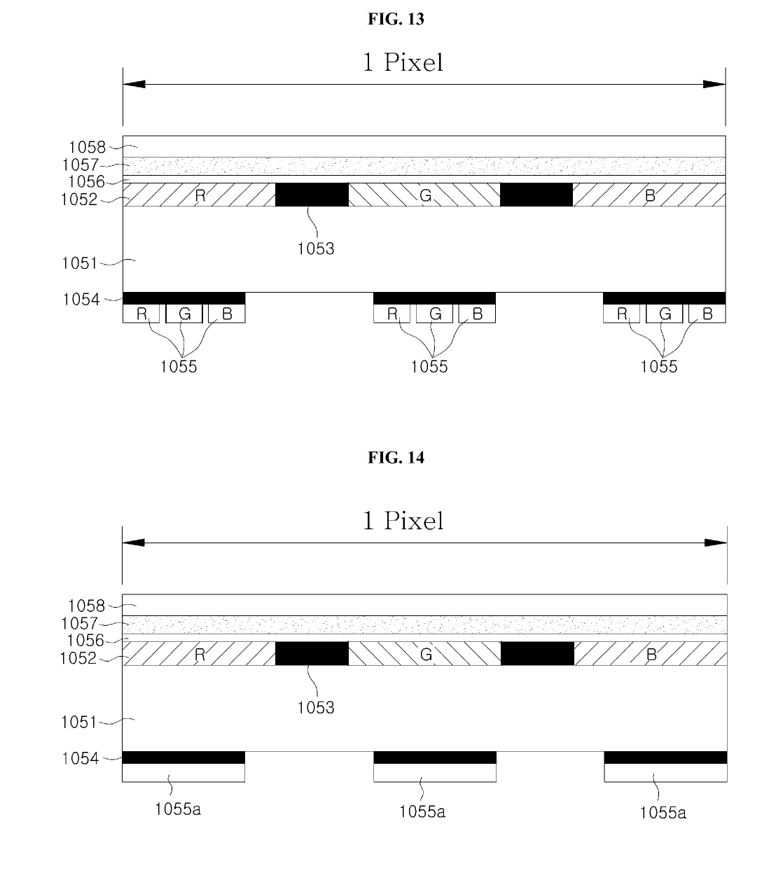

Then, referring FIG. 13, an example regarding the structure of OLED and method of manufacturing the same which applies to color filter as display device will be explained.

FIG. 13 shows the structure of OLED applying to a color filter. OLED of the example comprises a substrate 1051, a color filter and a black matrix 1053 formed in the front surface of the substrate 1051, a protective film 1056 which covers and protects the color filter 1052 and the black matrix 1053, a polarization film 1058 adhered in the rear surface of the protective film 1056 by adhesive 1057, ITO electrode layer 1054 formed in the rear surface of the substrate 1051, and an organic light emitting unit 1055 formed on the ITO electrode layer 1054.

The organic light emitting unit 1055 consists of electron injection layer, electron transfer layer, organic light emitting layer, hole transfer layer, and hole injection layer, and is constituted with 3 sub-pixels which emit the light with red, green, and blue wavelength per each pixel respectively to realize a white light. The white light emitted by the organic light emitting unit 1055 is filtered by the color filter 1054 to emit only the wavelength corresponding with each pixel to the outside, and realize full color of OLED.

It is preferable that the color filter 1052 is constituted with the material having the reflective index of above 1.55 higher than the reflective index of general color filter 1052 (about 1.5) so as to advance the amount of the light penetrated through the color filter 1052 and polarization film 1058. When the color filter 1052 is constituted with the material having high reflective index of above 1.55, the reflection angle of incident light of the color filter to which the light is emitted from the substrate 1051 decreases, and critical angle between the color filter 1052 and polarization film 1058 increases so that probability that a light passing the substrate 1051 will pass the interface between the color filter 1052 and polarization film 1058 increases as illustrated in figure.

After the color filter 1052 and black matrix 1053 are printed on the release film F (referring to FIG. 9) by the identical method with the above-described method of manufacturing LCD, and a protective film 1056, adhesive 1057, and polarization film 1058 are applied thereon in order, the color filter 1052, black matrix 1053, protection film 1056, adhesive 1057, and polarization film 1058 on the release film F are transferred to the substrate 1051, and can be adhered in front surface of the substrate 1051.

Besides the above-described method, the display device can be manufactured by the method of forming a color filter 1052 and black matrix 1053 on a release film F, forming a protective film 1056, an adhesive 1057, and a polarization film 1058 on another release film F, transferring the color filter 1052 and black matrix 1053 in front side of the substrate 1051 in advance, and transferring the protective film 1056, adhesive 1057, and polarization film 1058 afterwards.

The method of forming the color filter 1052, black matrix 1053, protective film 1056, adhesive 1057, and polarization film 1058 on the release film F can be executed in identical or similar method with the example for the above-described method of manufacturing LCD. Therefore, a detailed explanation of the above-described method is omitted.

FIG. 14 illustrates another example for the structure of OLED to be realized by the method of manufacturing display device according to the present invention. OLED of the example is the same as the basic structure of OLED which is explained referring to FIG. 13. However, there is a difference that all the organic light emitting units 1055 which constitute sub-pixels of each pixel emit white light.

When all the organic light emitting units 1055 are constituted so as to emit white light as above-described, there are advantages that life time increases compared with the OLED of the above-described example, and color reproducibility is advanced. That is, when the organic light emitting units 1005 consist of Red, Green, and Blue as OLED of the above-described example, an organic light emitting unit 1005 of Blue lessens life time of entire OLED due to having short life time compared with the organic light emitting layer of another color, and decreases color reproducibility. However, when all the organic light emitting units 1055 are constituted with white light, the units have an advantage that the life time becomes uniform and longer.

A color filter 1052, black matrix 1053, protective film 1056, adhesive 1057, and polarization film 1058 of OLED in the example are formed on the substrate 1051 uniformly and precisely by the method transferred and adhered on the substrate 1051 after being applied on the release film F in advance in the same way of above-described example.

Then, referring to the attached figures, a preferable example of method of manufacturing TFT in LCD device according to the present invention will be explained in detail.

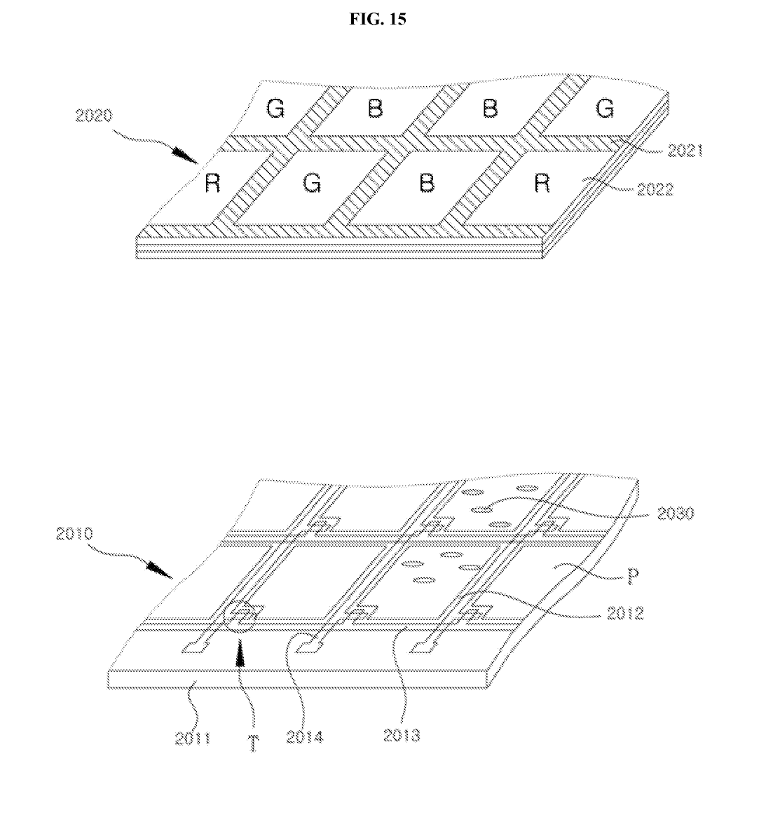

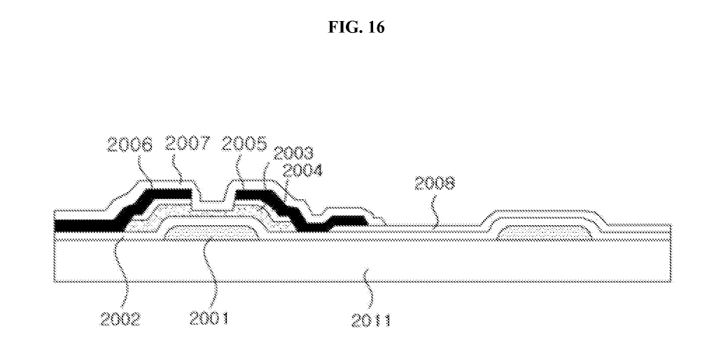

First, referring FIG. 15 and FIG. 16, a structure of LCD device will be explained approximately as follows:

As illustrated in FIG. 15, a LCD device is constituted with an array substrate 2010 and color filter substrate 2020 subtended, and a liquid crystal layer 2030 is interposed between the array substrate 2010 and color filter substrate 2020.

The array substrate 2010 consist of TFT, common electrode (not illustrated), and pixel electrode 2012 per a number of pixels defined to transparent glass substrate 2011.

The common electrode (not illustrated) and pixel electrode 2012 is constituted with separated on the array substrate 2010 each other in parallel, and is constituted with a gate line 2013 extended along the one side of the pixel, a data line 2014 extended in the perpendicular direction against the gate line, and common wiring (not illustrated) applying a voltage to the common electrode (not illustrated).

The color filter substrate 2020 is constituted with a gate line 2013 and data line 2014 on the transparent glass substrate, a black matrix 2021 in the part corresponding with TFT, and a color filter 2022 corresponding with the pixel.

As illustrated in FIG. 16, the TFT comprises a gate electrode 2001, an active layer 2003, 2004 positioned between dielectric layer 2002 above the gate electrode 2001, source electrode 2005 and drain electrode 2006 separated above the active layer 2003, 2004 each other, and an oxidation resistant layer 2007 surrounding with the upper position of the source electrode 2005 and drain electrode 2006. The active layer 2003, 2004 can consist of an amorphous silicon layer 2003 and n⁺ amorphous silicon layer 2004.

The gate electrode 2001 can consist of the metal such as Cr, Al, Mo, Cu and ITO, and the dielectric layer can consist of SiNₓ. The source electrode 2005 and drain electrode 2006 can consist of the metal such as Cr, Al, Mo and Cu, and the oxidation resistant layer can consist of SiNₓ. It is preferable that the oxidation resistant layer is formed in the thickness of 2500 Å approximately.

The liquid crystal layer 2030 is worked by the plane switching of the common electrode (not illustrated) and pixel electrode 2012.

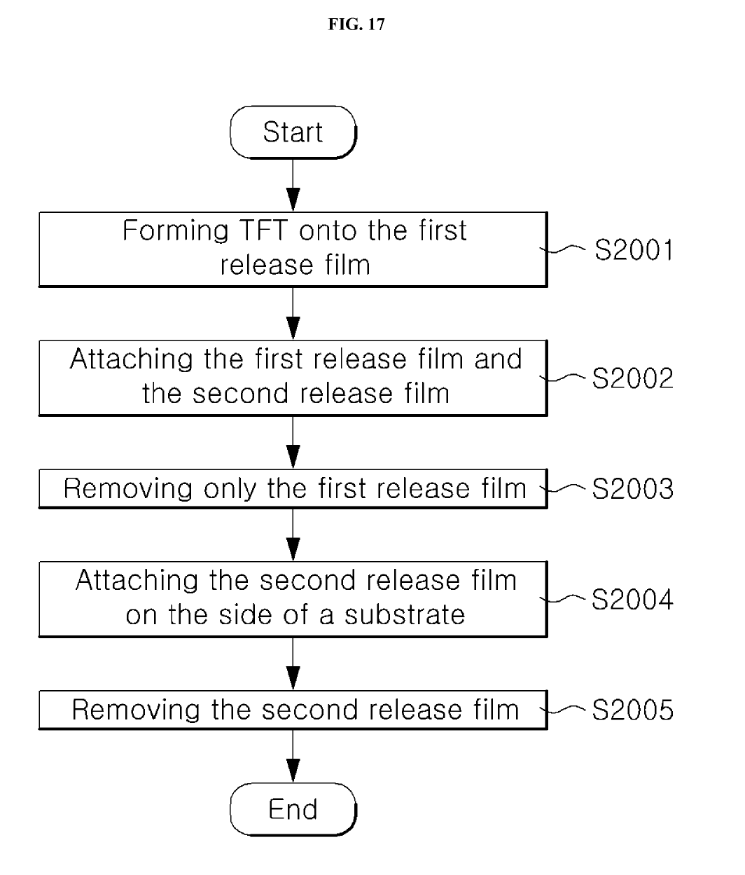

Then, referring to FIG. 17 to FIG. 23, one example of the method of manufacturing TFT illustrated in FIG. 16 will be explained in detail

As illustrated in FIG. 17, the method of manufacturing TFT according to the present invention consists of a step adhering TFT on one side of the first release film S2001, a step adhering the second release film on the side on which TFT of the first release film is adhered S2002, a step separating the first release film to transfer TFT to the second release film S2003, a step adhering the side of the second release film on which TFT is adhered on the substrate S2004, and a step only the second release film from the substrate with the state in which the TFT is transferred on the substrate S2005.

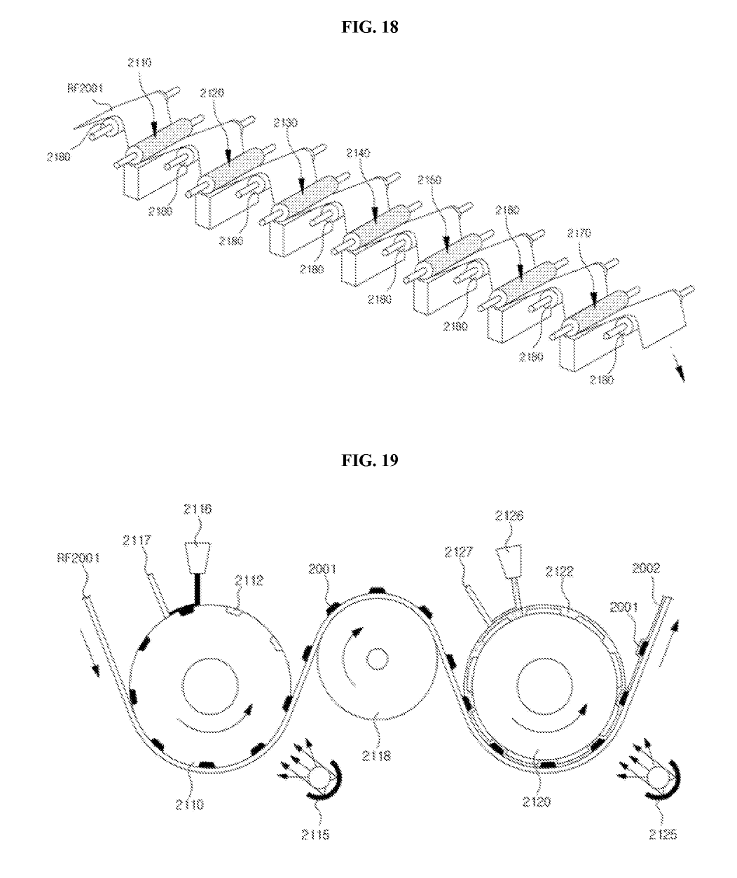

The step S2001 consists of the step laminating TFT structure on the one side of the first release film RF2001 with set-up pattern in order by using TFT laminating apparatus having a number of printing roller 2110, 2120, 2130, 2140, 2150, 2160, and 2170 as illustrated in FIG. 18 and FIG. 19.

If explaining further specifically, the TFT laminating apparatus comprises a gate electrode printing roller 2110, a dielectric layer printing roller 2120, the first active layer printing roller 2130 forming an amorphous silicon layer 2003 (referring to FIG. 16), ITO layer printing roller 2140 printing ITO layer 2008 (referring to FIG. 16), the second active layer printing roller 2150 forming n⁺ amorphous silicon layer 2004 (referring to FIG. 16), and oxidation resistant layer printing roller 2170. The first release film RF 2001 passes with adhered on the external surface of the printing rollers one after another.

Rollers for applying tension are arranged between each of the printing rollers 2110˜2170 to sustain the tension of the first release film RF2001.

A formation groove of the pattern corresponding with the wanted structure of TFT is formed in the printing rollers 2110˜2170. For example, the formation groove 2112 of the pattern corresponding with the pattern of a gate electrode 2001 (referring to FIG. 16) is formed in the gate electrode printing roller 2110, and the formation groove 2122 of the pattern corresponding with a dielectric layer 2002 (referring to FIG. 16) is formed in the dielectric layer printing roller 2120.

As illustrated in FIG.19, material suppliers 2116, 2126 to which material for forming the structure of TFT is supplied, scribers 2217, 2127 whose one side is connected and installed on the external surface of the printing rollers 2110˜2170 to enable that supplied material is stored in formation grooves 2112, 2122 only, and is not applied in parts except from the formation grooves 2112, 2122, and UV hardening apparatuses 2115, 2125 are constituted in one side of each of the printing rollers 2110˜2170.

A process of forming TFT on the first release film RF2001 by using TFT laminating device which is constituted as the above-described will be explained as follows:

Material for forming gate electrode is supplied through the material supplier 2116 installed in the upper side of the gate electrode printing roller 2110.

After metal material supplied in the upper side of the gate electrode printing roller 2110 is stored in the formation groove 2112, is adhered on the surface of the first release film RF2001 in the part connected with the first release film RF2001, and is hardened by UV hardening apparatus 2115, the metal material moves together with adhered with the surface of the first release film RF2001 in the site separated from the gate electrode printing roller 2110.

The first release film RF2001 of which a gate electrode 2001 (referring to FIG. 16) is formed with set-up pattern on one side as above-described passes a dielectric layer printing roller 2120, and material for forming the dielectric layer is supplied to the dielectric layer printing roller 2120 by the identical process with the above-mentioned so that a dielectric layer 2002 is laminated on a gate electrode 2001 with the set-up pattern.

Then, the first release film RF2001 passes the first active layer printing roller 2130, ITO layer printing roller 2140, the second active layer printing roller 2150, source/drain printing roller 2160, and oxidation resistant layer printing roller 2170 in order so that the active layers 2003, 2004 (referring to FIG. 16), ITO layer 2008, source electrode 2005, drain electrode 2006, and oxidation resistant layer 2007 are laminated one after another by the identical process with the above-mentioned.

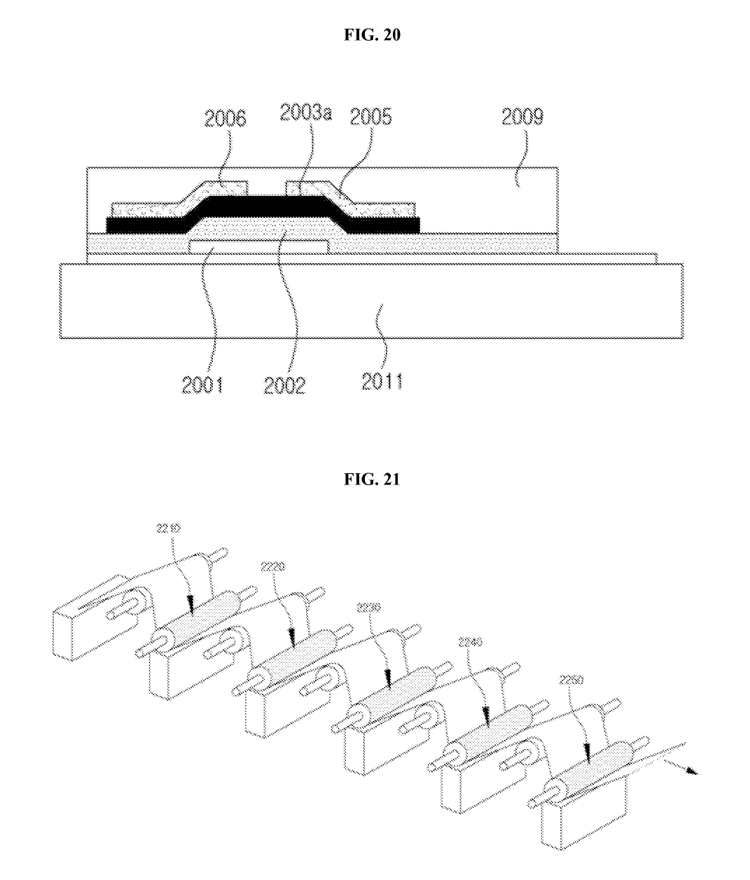

Meanwhile, TFT laminating apparatus for forming TFT on the first release film RF2001 can be altered according to the structure of TFT to be manufactured. For example, in case of manufacturing TFT constituted with a gate electrode 2001, dielectric layer 2002, active layer 2003a, source electrode 2005, drain electrode 2006, and MOS capacitor 2009 as illustrated in FIG. 20, TFT laminating apparatus can be constituted with a gate electrode printing roller 2210, dielectric layer printing roller 2220, active layer printing roller 2230, source/drain electrode printing roller 2240, and MOS capacitor printing roller 2250 as illustrated in FIG. 21.

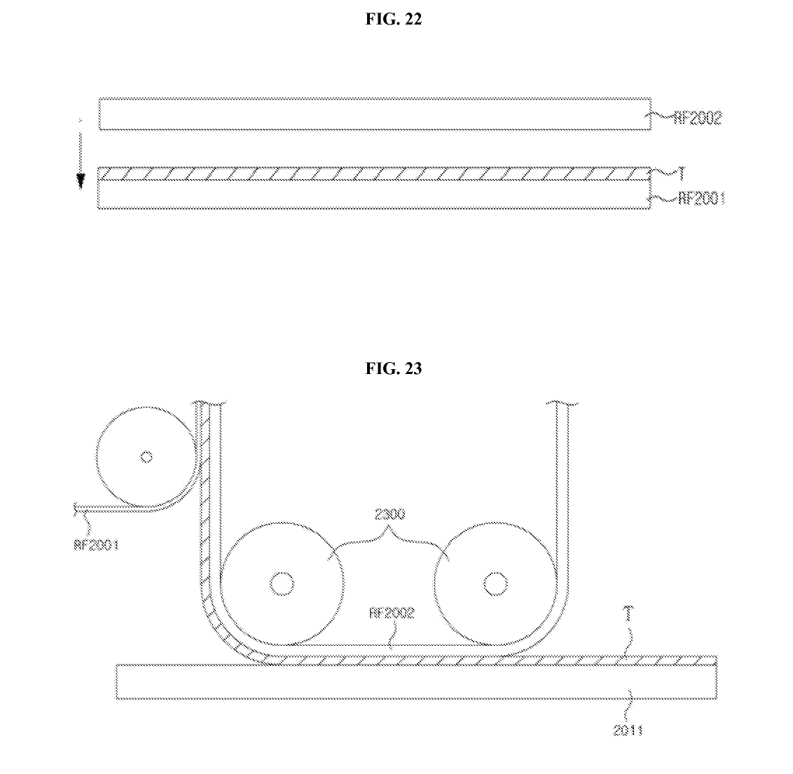

When TFT with wanted structure is formed on the first release film RF2001 as above-described, the first release film RF2001 is adhered with the second release film RF 2002 as illustrated in FIG. 22.

Then, as illustrated in FIG. 23, the first release film adhered with the second release film moves to the position for adhesion process with a substrate, the first release film RF2001 is separated so that TFT is moved and adhered on the second release film RF2002, and the second release film RF2002 is pressurized against the substrate 2001 by using a pressurization roller 2300 to transfer TFT on the surface of the substrate 2011 while passing the second release film RF2002 between the pressurization roller 2300 and substrate 2011.

If the second release film RF2002 is separated in this state, TFT remains in the state adhered on the external surface of the substrate 2001 with wanted pattern.

According to the present invention, TFT is formed on the substrate 2011 after TFT is printed on the release film RF2001, RF2002 with wanted structure and pattern and is transferred on the substrate 2011. Therefore, the process for manufacturing TFT has advantages that the process becomes very simple and easy.

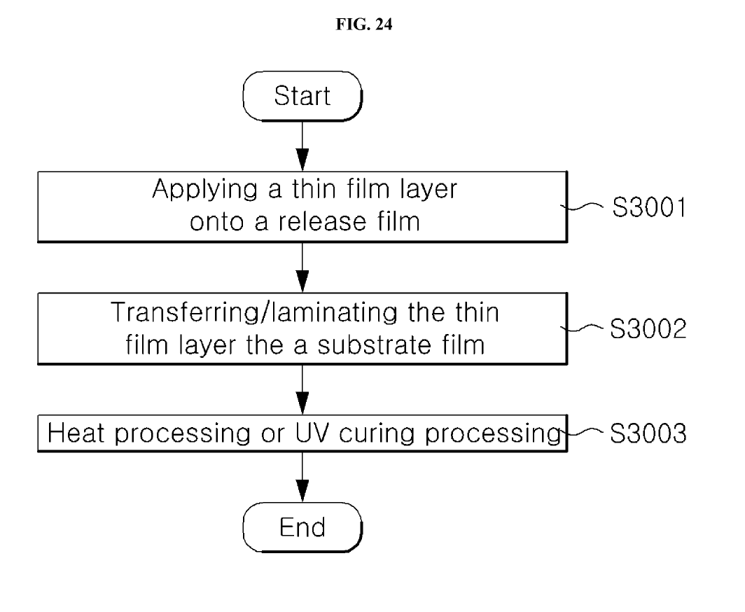

Then, referring to FIG. 24, the method of manufacturing display device according to the present invention approximately consists of a step of forming a certain thin film layer on a number of release films respectively S3001, a step of executing a process to separate the release film consecutively after adhering thin film layer of each release film on the surface of a substrate or base film to layer a number of thin film layers on the surface of the substrate or base film S0332, and a step of laminating thin film layers on the substrate or bas film, or heating or UV-hardening the substrate or base film after laminating thin film layers on the substrate S3003.

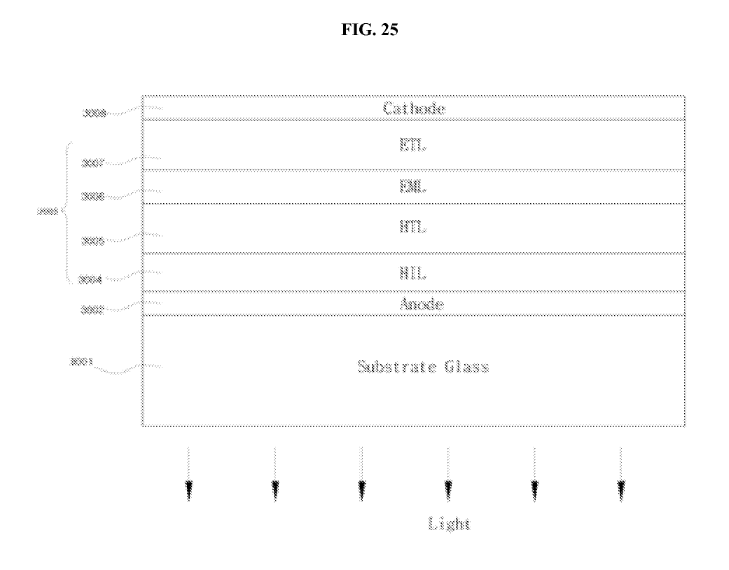

Referring FIG. 25 to FIG. 27, a method of manufacturing Polymer Light Emitting Diode (PLED) as one example of a method of manufacturing display device according to the present invention will be explained as follows:

First, as illustrated in FIG. 25, PLED consists of an anode ITO electrode layer 3002 laminated on a glass substrate 3001 in order, an organic thin film layer 3003, and a cathode electrode layer 3008.

Here, the organic thin film layer 3003 can consist of Hole Injection Layer (HIL) 3004, Hole Transport Layer (HTL) 3005, Emitting Layer (EML) 3006, and Electron Transport Layer (ETL) 3007.

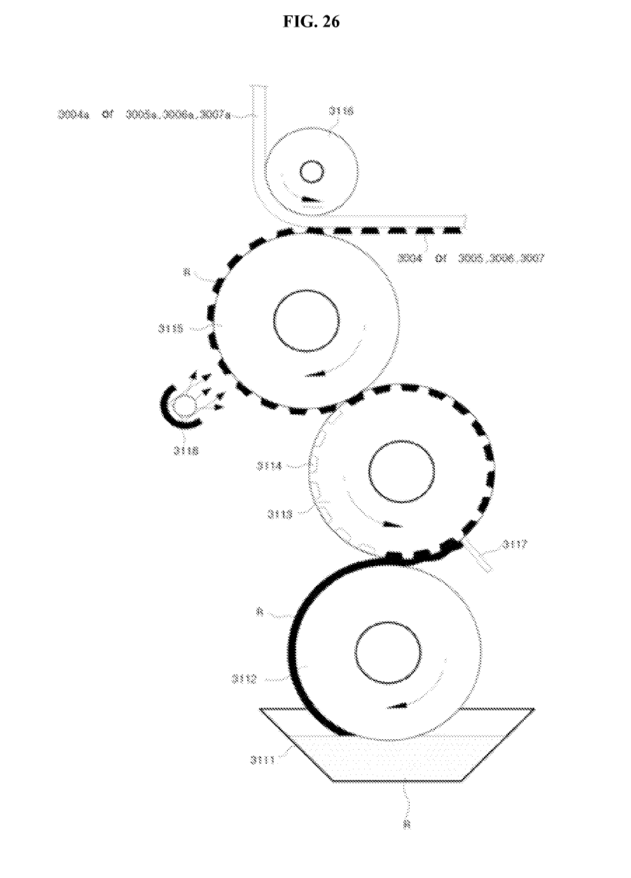

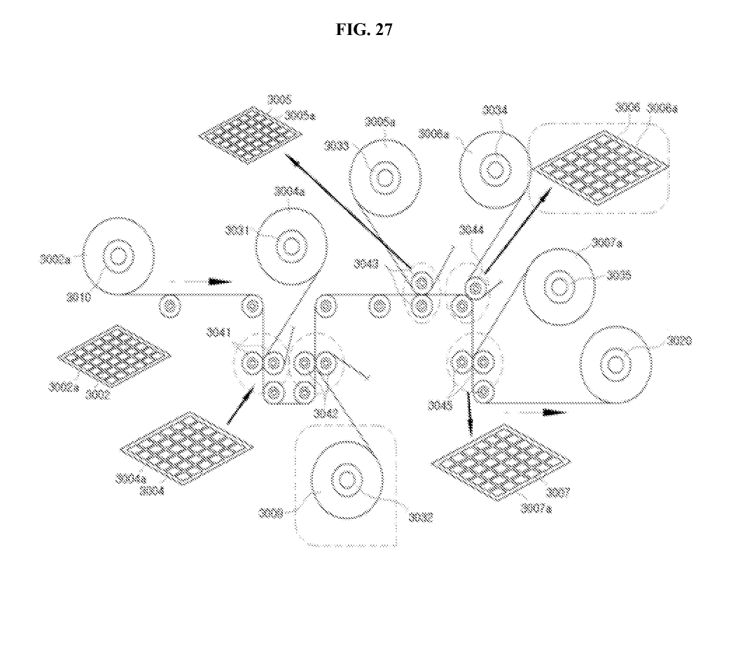

FIG. 26 and FIG. 27 illustrate one example of apparatus for manufacturing PLED with above-described structure by applying a method of manufacturing display device according to the present invention.

First, an anode ITO electrode layer is deposited on a base film made of polymer such as PAT to fabricate an electrode film 3002a, and HIL 3004, HTL 3005, EML 3006, and ETL 3007 are deposited with a certain pattern on a number of release films 3004a, 3005a, 3006a, and 3007a by using an apparatus for manufacturing organic thin film layer with method of mixing off-set technology and roller scribing technology as illustrated in FIG. 26.

The apparatus for manufacturing organic thin film layer illustrated in FIG. 26 comprises a resin supplying part 3111 in which a polymer resin for forming organic thin film layer R (for example, HIL) is stored, a resin supply roller 3112 which is installed in the upper position of the resin supplying part 3111 and is sunken in the organic thin film resin R which the external side of the lower part is stored in the resin supplying part 3111 thereof, a pattern formation roller 3113 which is installed with connected in the upper position of the resin supply roller 3112 and pattern grooves 3114 of the patterns corresponding with the organic thin film layers in the external surface thereof are formed to receive the resin inside the pattern grooves 3114 from the external surface of the resin supply roller 3112, a blanket roller 3115 which is installed with connected in the upper position of the pattern formation roller 3113 to receive the resin from the pattern grooves 3114 of the pattern formation roller 3113, and a pressurization roller 3116 which is installed with connected in the upper position of the blanket roller 3115 to pressurize release films 3004a, 3005a, 3006a, and 3007a passing the external surface of the blanket roller 3115 against the blanket roller 3115, and to adhere the resin for organic thin film to the release films 3004a, 3005a, 3006a, and 3007a.

In one side of the pattern formation roller is installed a scriber 3117 which removes the resin deposited on the external surface of the pattern formation roller 3113 so as that the resin does not remove in the part except the pattern groove 3114, and in one side of the blanket roller 315 is installed UV hardening apparatus 3118 which radiates UV to the external side of the blanket roller 3115 to harden an resin for organic thin film R.

The following explanation is to a process that organic thin film layers 3004, 3005, 3006, and 3007 are formed on the release films 3004a, 3005a, 3006a, and 3007a by the apparatus for manufacturing organic thin film layer 3010 constituted as above-described.

A resin for organic thin film R of the resin supplying part 3111 is deposited on the external side of the resin supply roller when the resin supply roller 3112 rotates. At this time, the pattern formation roller 3113 receives the resin for organic thin film R deposited on the resin supply roller 3112 while rotating in reverse direction with the resin supply roller 3112.

While the resin for organic thin film R transferred to the pattern formation roller 3113 passes scriber 3117, the resin deposited on the external side of pattern groove 3114 is removed, and only the resin stored inside the pattern groove 3114 remains.

The resin for organic thin film R stored inside pattern groove 3114 of the pattern formation roller 3113 is moved to the external side of blanket roller 3115 whose surface energy is the higher than that of pattern formation roller 3113.

The resin for organic thin film R moved to the blanket roller 3115 is hardened by UV hardening apparatus 3118 to have a certain viscosity, then the resin is adhered on one side of release films 3004a, 3005a, 3006a, and 3007a passing between pressurization roller 3116 and blanket roller 3115.

The organic thin film layer can be formed on the release film by the method such as printing method or inkjet method different from the example.

Meanwhile, when HIL 3004, HTL 3005, EML 3006, or ETL 3007 are deposited on each release film 3004a, 3005a, 3006a, and 3007a as above-described, organic thin film layers of each release film 3004a, 3005a, 3006a, and 3007a are laminated on an electrode film 3002a in order by using the apparatus as the above-illustrated FIG. 27.

If explaining further specifically, the electrode film 3002a on which ITO electrode layer is deposited is equipped with a feeding spool 3010 and one side of the electrode film 3002a passes the first pressurization roller to the fifth pressurization roller 3041˜3045 to be wound to a winding spool 3020. To the spools 3031˜3035 is equipped a functional film 3009 which protects release films 3004a, 3005a, 3006a, and 3007a and one side of the electrode film 3002a. For illumination for the spools, the first spool 3031 is defined as the spool equipping with a release film 3004a on which the HIL 3004 is deposited, the second spool 3032 is the spool equipping with the functional film 3009, the third spool 3033 is the spool equipping with a release film 3005a on which the HTL 3005 is deposited, the fourth spool 3034 is the spool equipping with a release film 3006a on which the EML 3006 is deposited, and the fifth spool is the spool equipping with a release film 3007a on which the ETL 3007 is deposited.

After the release films 3004a, 3005a, 3006a, and 3007a equipped with the first spool to the fifth spool 3031˜3035 pass the first pressurization roller to the fifth pressurization roller 3041˜3045 with the electrode film 3002a respectively to be adhered on the side of the electrode film 3002a, the release films are wound to a spool for collection.

When the winding spool 3020 and the spool for collection (not illustrated) rotate to wind up the electrode film 3002a and release films 3004a, 3005a, 3006a, and 3007a in the state where the electrode film 3002a and release films 3004a, 3005a, 3006a, and 3007a as above-described are equipped, thin film layers 3004, 3005. 3006, and 3007 of the release films 3004a, 3005a, 3006a, and 3007a are transferred on the electrode film 3002a while the electrode film 3002a and release films 3004a, 3005a, 3006a, and 3007a pass among the first pressurization roller to the fifth pressurization roller 3041˜3045.

That is, the release film 3004a on which HIL 3004 is deposited is transferred and adhered on the external surface of ITO electrode layer of the electrode film 3002a while passing the first pressurization roller 3041 with the electrode film 3002a. The HIL 3004 is adhered on the electrode film 3002a except additional adhesive because the HIL 3004 consists of polymer material.

Subsequently, the functional film 3009 is adhered on the other side or the electrode film 3002a, that is the reverse side of the side on which ITO electrode layer is formed, while the electrode film 3002a and functional film 3009 pass the second pressurization roller 3042.

Then, while the electrode film 3002a passes the third pressurization roller 3043, the fourth pressurization roller 3044, and the fifth pressurization roller 3045 one after another, HTL 3005, EML 3006, and ETL 3007 are transferred and laminated on HIL 3004 which is laminated on the electrode film 3002a one after another. Release films 3004a, 3005a, 3006a, and 3007a and functional film 3009 passing the first pressurization roller to the fifth pressurization roller 3041˜3045 are wound to the spool for collection (not illustrated).

As above-described, HIL 3004, HTL 3005, EML 3006, and ETL 3007 are laminated on one side while passing the first pressurization roller to the fifth pressurization roller 3041˜3045, and the electrode film 3002a of which the functional film 3009 is adhered on the other side is wound to the winding roller 3020.

Meanwhile, it is preferable that the electrode film 3002a and release films 3004a, 3005a, 3006a, and 3007a are executed by heating or UV hardening process to increase the interface adhesive strength of each thin film layer after passing the electrode film 3002a and release films 3004a, 3005a, 3006a, and 3007a between pressurization rollers 3041˜3045, and transferring and laminating the thin film layers on the electrode film 3002a as above-described. Of course, the heating or UV hardening process can be executed in the process laminating a number of thin film layers.

The electrode film 3002a wound to the winding roller 3020 moves another process position. Then, the electrode film 3002a is adhered on a glass substrate 3001 (referring to FIG. 24) after a functional film 3009 is separated from the electrode film 3002a, and a cathode electrode 3008 (referring to FIG. 24) is deposited on the laminated organic thin film layer 3003 so that display device is constituted.

The method of manufacturing display device according to the above-described example is to the method of manufacturing PLED. However, the present invention can be applied to the display device such as OLED in the same or analogous way.

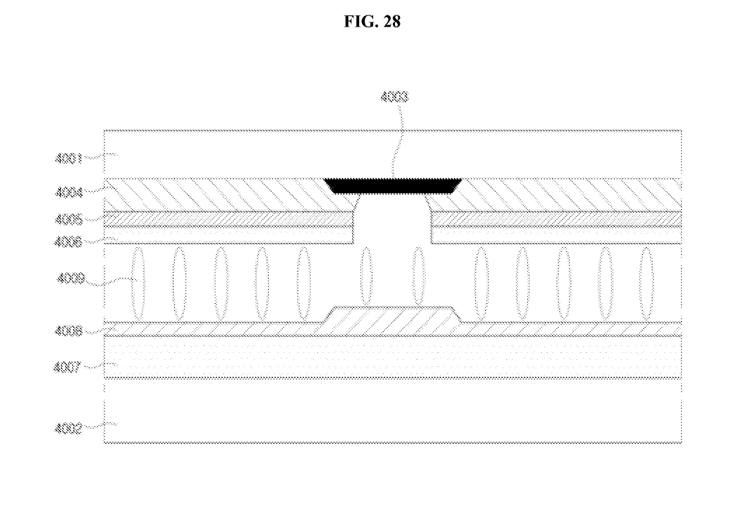

The following explanation is to one example for the structure of In-cell typed LCD referring to FIG. 28. As illustrated in FIG. 28, In-cell typed LCD consists of an upper substrate 4001, lower substrate 4002, a black matrix 4003 and color filter 4004 formed beneath the upper substrate 4001, In-cell phase difference film 4005 formed in the lower side of the color filter 4004, ITO layer 4006 laminated beneath the In-cell phase difference film 4005, ITO layer 4007 and TFT 4008 formed on the lower substrate 4002, and liquid crystal layer 4009 injected between the upper substrate 4001 and lower substrate 4002.

The In-cell phase difference film 4005 is defined as the polarization film consisting of PVA/TAC/PVA, and compensating the phase difference.

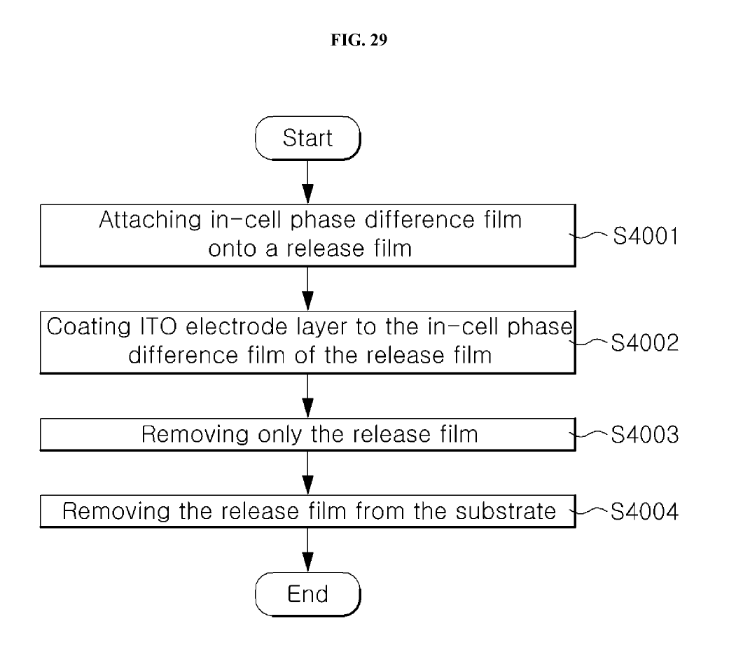

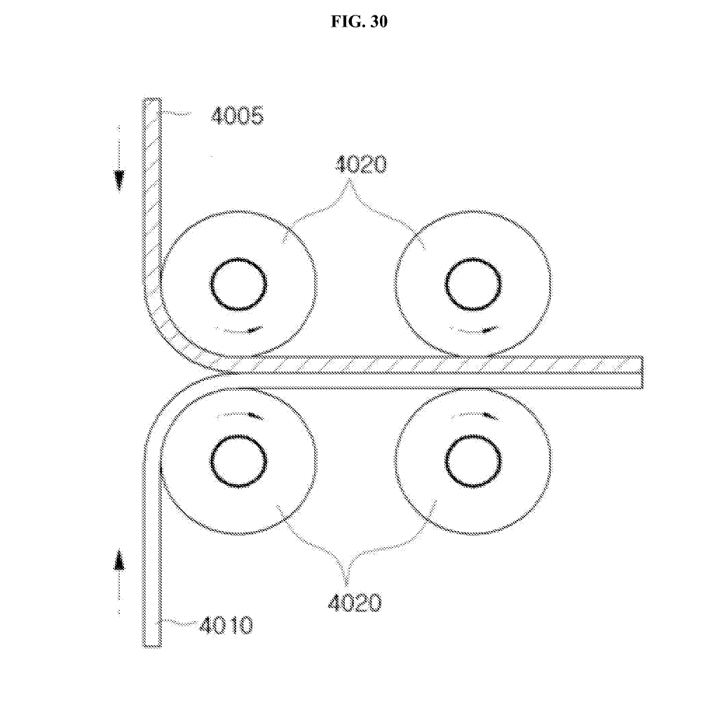

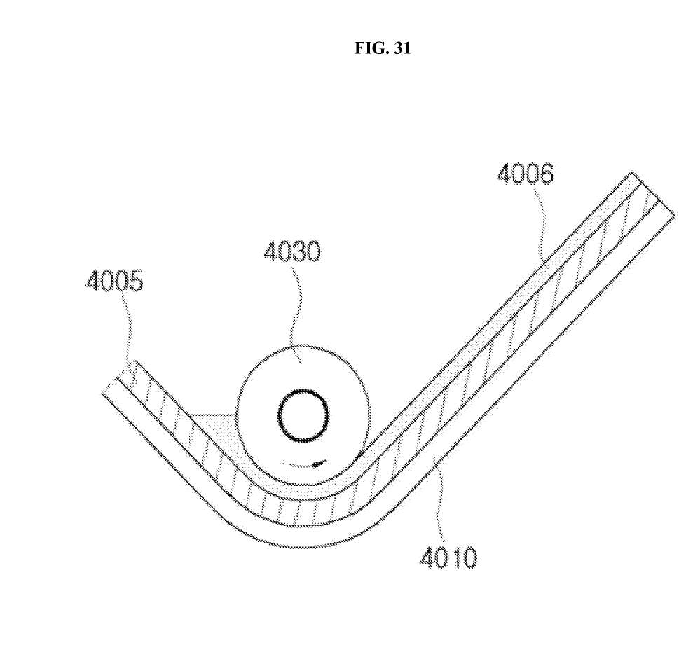

The following explanation is to one example for method of manufacturing In-cell typed LCD according to the present invention referring to FIG. 29 to FIG. 33.

Referring to FIG. 29, the method of manufacturing In-cell typed LCD according to the present invention comprises a step adhering In-cell phase difference film on one side of a release film S4001, a step forming ITO layer on In-cell phase difference film of the release film S4002, a step adhering the side of the release film on which the In-cell phase difference film and ITO electrode layer is applied on a substrate or color filter formed on the substrate S4003, and a step separating only the release film from the substrate in state in which the In-cell phase difference film is transferred on the substrate or color filter formed on the substrate S4004.

As illustrated in FIG. 30, In-cell phase difference film 4005 and release film 4010 are pressurized to make the In-cell phase difference film 4005 adhered on one side of the release film 4010 on which an adhesive is applied while passing among a number of press rollers 4020 connected mutually at the same time. Here, the In-cell phase difference film 4005 is the polarization film comprising PVA/TAC/PVA as above-described.

A step of forming ITO layer 4006 on the release film 4010 (Step S4002) is executed after In-cell phase difference film 4005 adheres on the side on which adhesive of the release film 4010 is applied as above-described. For example, the step S4002 can be executed by wet coating method by which ITO resin is coated on the side of In-cell phase difference film 4005 while delivering the release film 4010 on which In-cell phase difference film 4005 adheres on the external surface of a roller for applying ITO resin 4030.

In this example, a step S4002 of forming ITO layer 4006 is executed consecutively after a step S4001. However, ITO layer 4006 can be formed on the external surface of In-cell phase difference film 4005 by sputtering method after the In-cell phase difference film 4005 on the color filter 4004 of the upper substrate 4001.

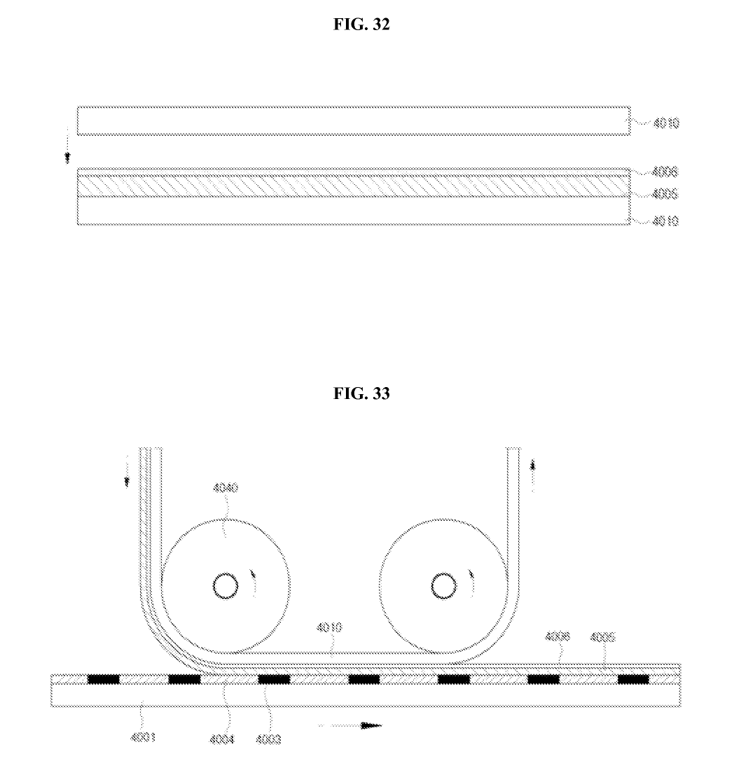

Then, as illustrated FIG. 32, when one release film 4010 (the first release film) is separated, and the other release film 4010 (the second release film) adheres on the external surface of In-cell phase difference film 4005 and ITO layer 4006 of the first release film, ITO layer 4006 and In-cell phase difference film 4005 remains adhered on the second release film 4010.

Then, as illustrated in FIG. 33, when the second release film 4010 is pressurized against the surface of the upper substrate 4001 while the second release film 4010 passes between upper substrate 4001 on which color filter 4004 is formed, and press roller 4040, In-cell phase difference film 4005 adheres to the external surface of color filter 4004 of the upper substrate 4001. In this state, when the second release film 4010 is separated, In-cell phase difference film 4005 and ITO layer 4006 remain adhered in order on the external surface of color filter 4004 of the upper substrate 4001.

In this example, upper substrate 4001-color filter 4004-In-cell phase difference film 4005-ITO layer 4006 are integrated mutually by the method of making In-cell phase difference film 4005 adhere on the color filter 4004 because the color filter 4004 is applied on the upper substrate in advance. However, color filter 4004-In-cell phase difference film 4005-ITO layer 4006 can be transferred at the same time by making the release film 4010 adhered on the substrate 4001 after applying color filter 4004 and black matrix 4003 on the release film 4010, and laminating In-cell phase difference film 4005 and ITO layer 4006 thereon on after another.

Also, in the above-described example, color filter 4004 was formed on the upper substrate 4001 and In-cell phase difference film 4005 and ITO layer 4006 were formed on the color filter 4004. However, In-cell phase difference film 4005 and ITO layer 4006 can be formed on the surface of the lower substrate 4002 instantly in case of forming In-cell phase difference film 4005 on the surface of the lower substrate 4002.

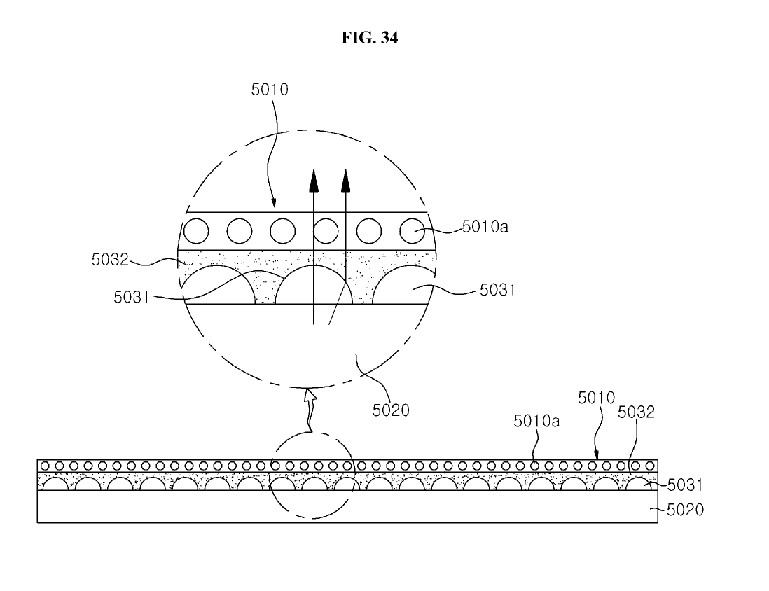

Then, FIG. 34 as a display device according to one example is cross sectional view illustrating main part of constitution of OLED. The display device of this example has the structure that a polarization film 5010 adheres on light emitting surface of glass substrate 5020 of OLED by an adhesive layer 5032 on which a number of lens patterns 5031 are formed.

Here, the adhesive layer 5032 and lens pattern 5031 are constituted with light path conversion means altering progress direction of the light emitted through light emitting surface of the substrate 5020 with making the polarization film 5010 adhere on the substrate 5020.

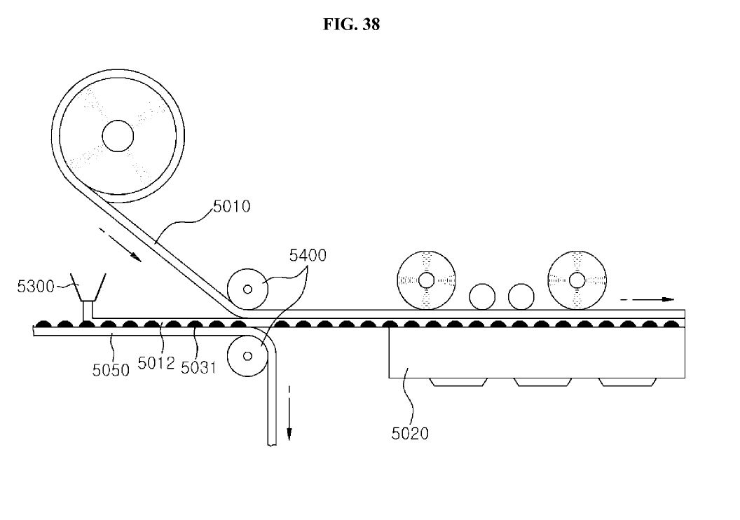

The polarization film 5010 adheres on glass substrate 5020 by the method of not adhering thereon after applying only adhesive on the glass substrate 5020, but putting release film 5050-polarization film 5010 complex on the glass substrate 5020 and separating from release film 5050 after adhering on the release film 5050 with adhesive layer 5032 and lens pattern 5031. The above-described method will be explained further specifically by referring to FIG. 38 afterwards.

Meanwhile, the lens pattern 5031 consists of the shape of hemispheric dome, polyhedron, circular cone, or poly pyramid to reflect a light and to change the progress direction of the light as above-described. The lens pattern 5031 can be arranged with the shape of dot or stripe on the upper surface of the substrate, and is preferable to be constituted with uniform height of face. However, in case where a faulty of optical visual angle occurs in display device, the height of the lens pattern can be compensated and constituted with various height of face to solve the faulty of optical visual angle. The above-described shape, arrangement and height of height of lens pattern were explained as one example. Therefore, all simple modifications or changes regarding shape, arrangement and height of height of lens pattern will be interpreted to belong to the range of the claims according to the present invention in equivalent range.

The lens pattern 5031 consists of the resin having the higher reflective index than that of the glass substrate 5020 so as to increase light extraction efficiency, and it is preferable that the adhesive layer 5032 consists of the resin having the higher reflective index than that of the lens pattern 5031.

When the lens pattern 5031 is interposed between a polarization film 5010 and glass substrate 5020 as above-described, the light which is emitted from a light source (not illustrated) to pass through the glass substrate 5020 is reflected so that the progress direction is changed, and optical loss decreases because a part of the light depolarized and reflected progresses by passing the polarization film 5010.

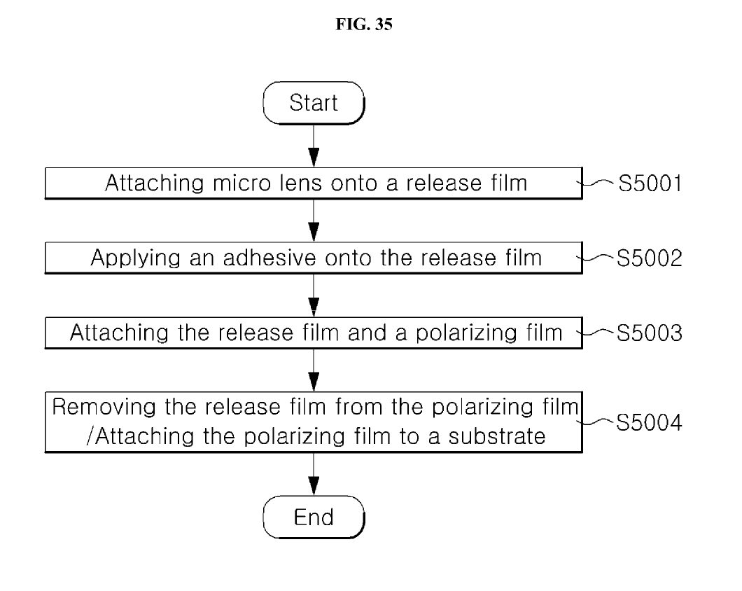

The following explanation is to a method of manufacturing display device of above-described example by referring to FIG. 35 to FIG. 38.

The method of manufacturing display device having above-described light path conversion means is approximately constituted with a step S5001 of making a number of lens patterns adhere on a release film, a step S5002 of applying adhesive layer on the surface of the release film on which the lens pattern adheres, a step S5003 of making a polarization film on the surface on which the lens pattern of the release film adheres, and a step S5004 of making the adhesive layer on which the polarization film and lens pattern are formed adhere on a glass substrate of display device while separating the release film from the complex of the polarization film-release film.

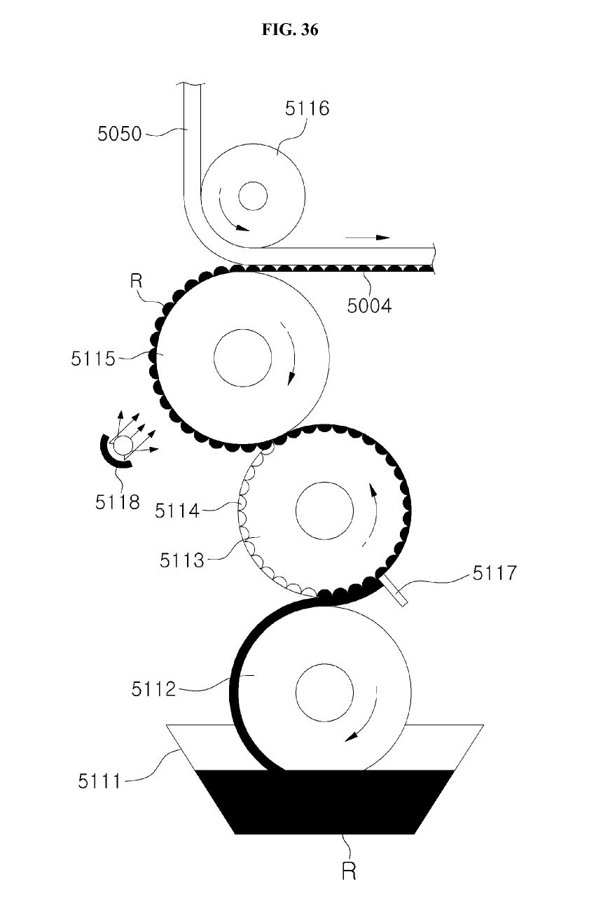

FIG. 36 illustrates an example of a device executing the step S5001 of making a number of lens patterns adhere on the release film among the above-mentioned steps. The device illustrated in FIG. 36 comprises a resin supply part 5111 in which resin for lens pattern is stored, a resin supply roller 5112 installed in the upper side of the resin supply part 5111 so as to be able to rotate, and sunken in the resin for lens pattern whose the external surface of lower part is stored in the resin supply part 5111, a pattern formation roller 5113 which is installed with connected in the upper side of the resin supply roller 5112 and of which formation grooves 5114 of the pattern corresponding with organic thin film layer in the external surface to receive the resin from the external surface of the resin supply roller 5112 to inside of the formation grooves 5114, a blanket roller 5115 installed with connected in the upper side of the pattern formation roller 5113 to receive the resin from the formation grooves 5114 of the pattern formation roller 5113, and a pressurization roller 5116 which is installed with connected in the upper side of the blanket roller 5115 and which pressurizes the release film 5050 passing the external surface of the blanket roller 5115 against the blanket roller 5115 to make the resin for lens pattern adhere on the release film 5050.

In one side of the pattern formation roller is installed a scriber 5117 removing the resin applied in the external surface of the pattern formation roller 5113 so that the resin is not applied in the part except the formation groove 5114, and in one side of the blanket roller 5115 is installed UV hardening apparatus 5118 which radiates UV to the external surface of the blanket roller 5115 to harden the resin R for lens pattern.

The following explanation is to the process where lens pattern 5031 is formed on the release film 5050 by the device constituted as above-described.

The resin R for lens pattern of the resin supply part 5111 is applied on the external surface of the resin supply roller 5112 when the resin supply roller 5112 rotates. At this time, the pattern formation roller 5113 receives the resin R for lens pattern applied on the resin supply roller 5112 while rotating in reverse direction with the resin supply roller 5112.

The resin applied on the external side of the formation groove 5114 of the resin R for lens pattern delivered to the pattern formation roller 5113 is removed by the scriber 5117, and only the resin stored inside the formation groove 5114 remains.

The resin R for lens pattern stored inside the formation groove 5114 of the pattern formation roller 5113 is delivered to the external surface of blanket roller 5115 whose surface energy is relatively the higher than that of pattern formation roller 5113 in the part connected with the blanket roller 5115.

The resin R for lens pattern delivered to the blanket roller 5115 is hardened by UV hardening apparatus 5118 to have a certain viscosity, and adheres on one side of the release film 5050 passing between pressurization roller 5116 and blanket roller 5115 afterwards.

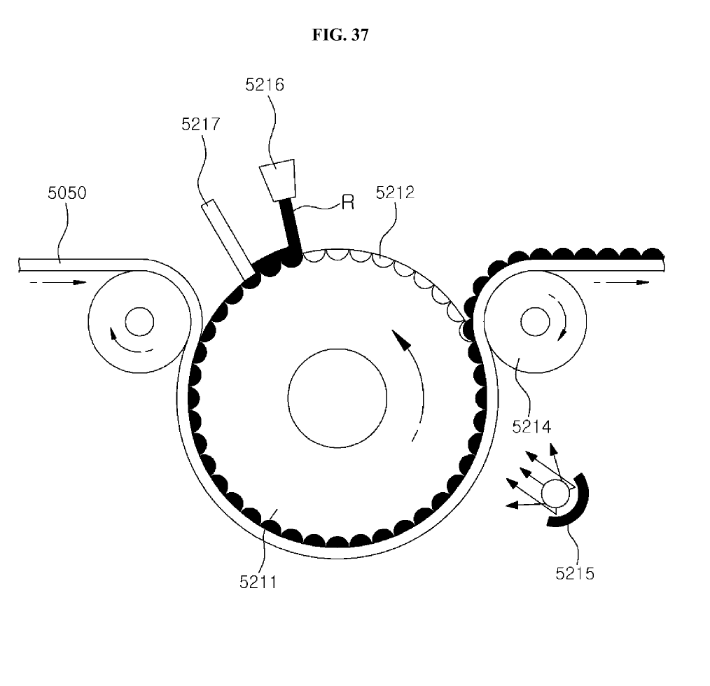

FIG. 37 illustrates another example of the device executing a step S5001 which makes a number of lens patterns on the release film. The apparatus illustrated in FIG. 37 comprises a formation roller 5211 where the formation groove 5212 of the pattern corresponding with lens pattern 5031 is formed, a resin supply part 5216 which supplies resin R for lens pattern in the upper side of the formation roller 5211, a couple of pressurization rollers 5214 which are installed with connected in both sides of the formation roller 5211, a scriber 5217 which removes the resin applied on the external surface of the formation roller 5211 to make the resin remain only inside formation groove 5212 of the formation roller 5211, and UV hardening apparatus 5215 which radiates UV for hardening the resin in one side of the formation roller 5211.

The process which makes lens pattern 5031 adhere on the release film 5050 is executed by using the apparatus constituted as above-described as follows:

As illustrated in FIG. 37, the resin for lens pattern is supplied on the external surface of formation roller 5211 rotating in one direction in the upper side of formation roller 5211 in state of progressing with connected with formation roller 5211 while the release film 5050 passes between the formation roller 5211 and pressurization roller 5214.

The resin R for lens pattern supplied on the external surface of the formation roller 5211 remains only inside formation groove 5212 with removed by the scriber 5217. The resin R for lens pattern stored inside formation groove 5212 of the formation roller 5211 is delivered to the release film 5050 and adhered in site where formation roller 5211 and release film 5050 are separated. Therefore, the lens pattern 5031 is formed on the release film 5050 with uniform pattern.

Although not illustrated in figure, the process that lens patterns 5030 are delivered and adhered to the second release film 5050 by making another release film 5050 adhere on the surface of the release film 5050 on which lens pattern 5031 is formed, after forming lens pattern 5031 on one side of the release film 5050.

As illustrated FIG. 38, the release film 5050 on which the lens pattern 5031 is applied as above-described adheres with the polarization film 5010 each other with passing a couple of pressurization rollers 5400 at the same time after delivering to the apparatus making polarization film 5010 and release film 5050 adhere, and applying adhesive on the side where lens pattern 5031 is formed by adhesive applying apparatus 5300 to form adhesive layer 5032.

Then, the release film 5050 is separated from the polarization film 5010-release film 5050 complex to remain only lens pattern 5031 and adhesive 5012, and the surface forming lens pattern of polarization film 5010 adheres on the side of glass substrate 5020 by adhesive 5012 to form display device such as illustrated in FIG. 34.

The process of making the polarization film 5010 adhere on the glass substrate 5020 of display device can be executed consecutively following the process making polarization film 5010 and release film 5050 each other. However, the process of making polarization film 5010 on glass substrate 5020 with separating release film 5050 at a time by moving the release film 5050-polarization film 5010 complex to separate process position.

Also, the polarization film 5010 can adhere on the glass substrate 5020 following the method of separating the first release film 5050, making the polarization film 5010 adhere on the glass substrate 5020, and separating the second release film 5050, after making the other release film 5050 (the second release film) adhere on the side where lens pattern 5031 is not formed in the side of the polarization film 5010 to interpose polarization film 5010 and lens pattern 5031 between two release films 5050.

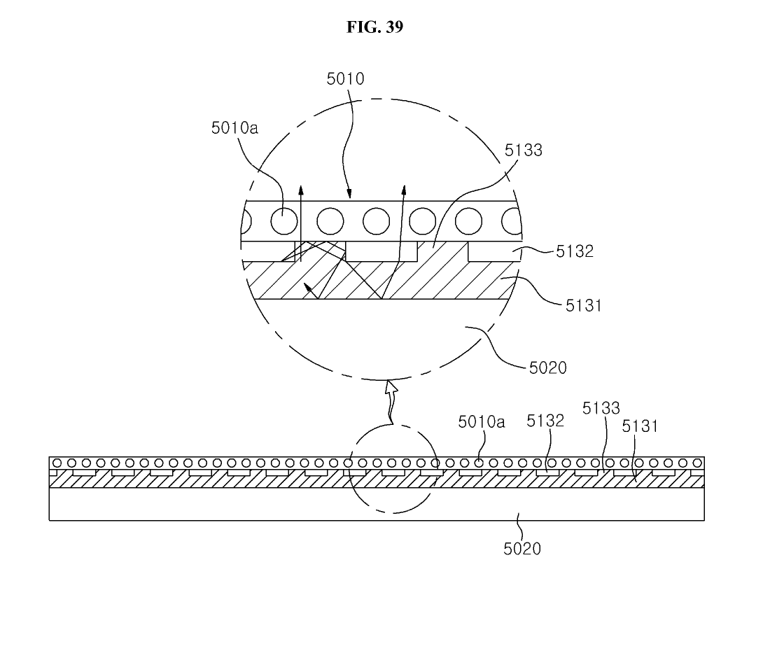

In the above-described example, the lens pattern 5031 constituting light path conversion means consists of another resin different from adhesive layer 5032 with uniform pattern in the adhesive layer 5032. However, as illustrated in FIG. 39, the light path conversion means can be formed with the structure where lens pattern 5132 with the shape of polyhedral bump (hexahedral bump in this example) is formed in a body, and the second adhesive layer 5133 is applied between each lens pattern 5132.

Here, the first adhesive layer 5131 is formed through the light emitting surface of substrate 5020 of display device to adhere on the light emitting surface, and the second adhesive layer 5133 adheres against the incident surface of polarization film 5010.

Also, the first adhesive layer 5131 consists of the resin having the higher reflective index than that of substrate 5020 and polarization film 5010, and the second adhesive layer 5133 consists of the resin having the lower reflective index than that of the first adhesive layer 5131. Therefore, the rays having the larger incident angle than critical angle of the rays which are emitted from the substrate 5020 to progress toward the lens pattern 5132 are totally reflected in the surface of the lens pattern 5132, and the progress direction is changed thereof. A part of rays of which the progress direction is changed progresses to light emitting surface of the lens pattern 5132 with angle below critical angle to be penetrated to the external site through the space of polarization axis 5010a of polarization film 5010 while being reflected from the lens pattern 5132 or the first adhesive layer 5131 again. That is, a part of rays to be absorbed to the polarization film 5010 by lens pattern 5131 is recycled to penetrate the polarization film 5010.

Therefore, the polarization film 5010 enables to decrease light absorption amount in polarization film 5010 comparing with conventional display device connected with light emitting surface of the substrate 5020. Lens pattern 5132 was illustrated to be separated from the substrate 5020 by the first adhesive layer 5131 in FIG. 39. However, the lens pattern can be constituted to adhere without separating the lens pattern 5132 from the substrate 5020. Regarding the separated distance of lens pattern 5132 and substrate 5020, all the minute changes of design which persons skilled in the art can alter easily will be interpreted to belong to the limit of right of the present invention.

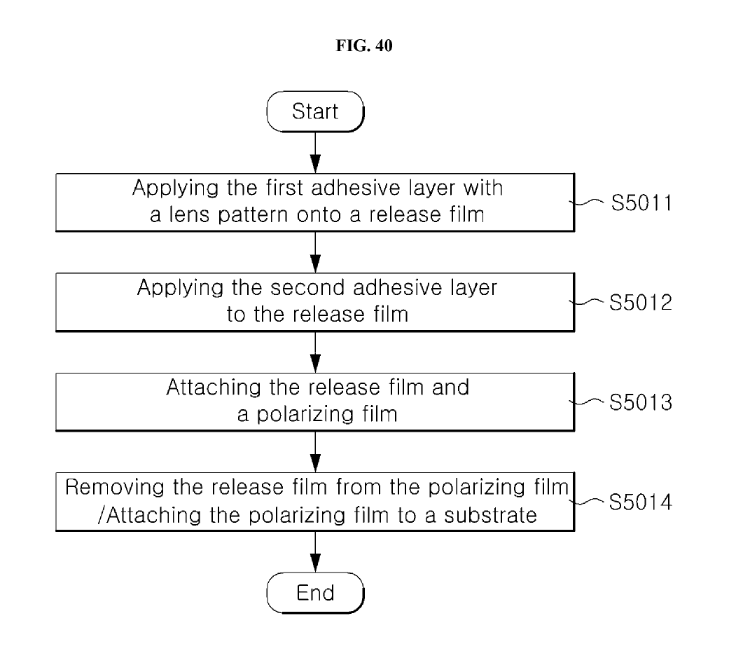

The first adhesive layer 5131 and the second adhesive layer 5133 adhere on the light emitting surface of the substrate 5020 of display device by similar method with the above-mentioned first example. That is, FIG. 40 illustrates the steps of a step S5011 of applying the first adhesive layer 5131 on one side of release film 5050 to form lens pattern 5132 by a printing method, a step S5012 of applying the second adhesive layer 5133 between lens patterns 5132 on the first adhesive layer 5131 by a printing method, a step S5013 of making the release film 5050 adhere to polarization film 5010, and a step S5014 of making the first and the second adhesive layer 5131, 5133 adhere on light emitting surface by the method that makes polarization film 5010 and the first and the second adhesive layer 5131, 5133 on the light emitting surface of the substrate 5020 while separating the release film 5050 from the complex of release film 5050-polarization film 5010.

As above-described, display device of the present invention enables that light path conversion means which consists of lens pattern 5031 (referring to FIG. 34) and adhesive layer 5032 (referring to FIG. 34), or the first adhesive layer 5131 with lens pattern 5132 (referring to FIG. 39) and the second adhesive layer 5133 is interposed between light emitting surface of substrate 5020 and polarization film 5010 to change into the angle below critical angle by reflecting a part of the rays emitted from substrate 5020. Therefore, the amount of the rays absorbed to polarization film 5010 decrease and light transmittance increases.

Display device of the present invention also is fabricated by the method of forming a light path conversion means on release film 5050, making polarization film 5010 adhere on the surface where light path conversion means of the release film 5050 is formed, and making the polarization film 5010 and light path conversion means adhere to the surface of substrate 5020 while separating release film 5050 from release film 5050-polarization film 5010 complex. Therefore, Display device of the present invention has advantage that fabrication can be executed very easily and simply.

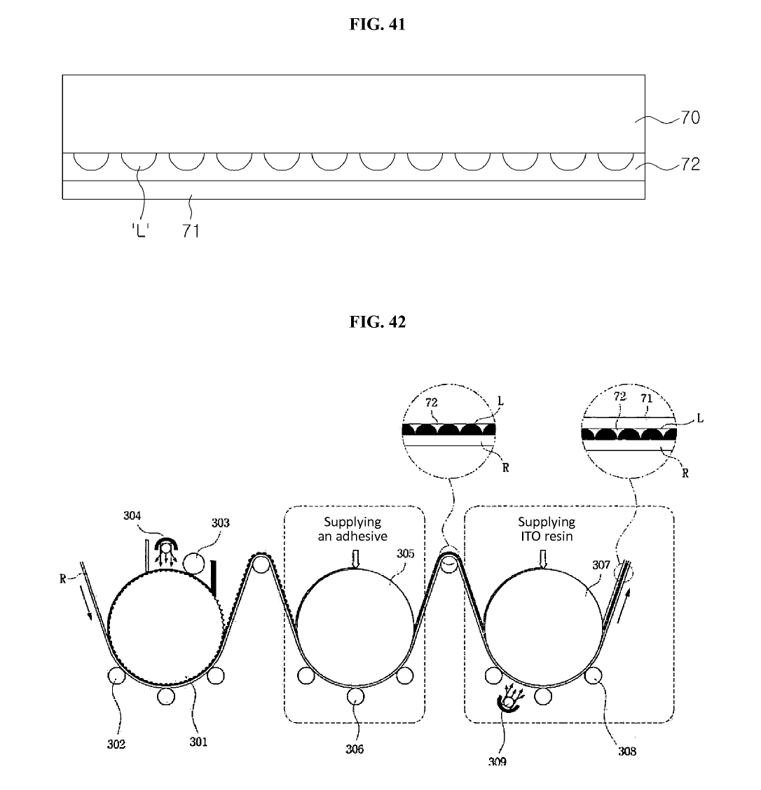

FIG. 41 and FIG. 42 illustrate constitution of a display device 70 where a number of micro lenses L and ITO layer 71 are formed on each surface of substrate 3, and an apparatus for manufacturing the display device 70. Display device of this example is fabricated through a step of forming micro lens L on adhesive application layer of release film R, a step of applying additional adhesive 72 for adhesion of ITO on adhesive application layer of release film R on which micro lens L is formed, a step of forming ITO layer 71 on the surface of release film R on which the adhesive 72 is applied, and a step of separating release film R from assembly which consists of the release film R-macro lens L and adhesive layer-ITO layer 71, and of making the film which consists of micro lens L, adhesive layer 72 and ITO layer 71 adhere on substrate 3.

Referring to FIG. 41 and FIG. 42, a process of manufacturing display device in which the micro lens L and ITO layer 71 are formed will be explained further specifically as follows:

First, resin for forming micro lens L is supplied to the lens formation roller 301 in state that release film R passes with adhering on the external surface of lower part of lens formation roller 301 in which formation groove is formed with the shape corresponding with micro lens L. At this time, the resin which is supplied to the lens formation roller 301 adheres on adhesive application layer of release film R in the lower position of lens formation roller 301 after being inserted inside each formation groove while passing scribing roller 303, and being hardened by UV hardening apparatus 304. At this time, it is preferable that a number of press roller 302 pressurize release film R against lens formation roller 301 in the lower side of the lens formation roller 301 so that micro lenses L adheres on release film R with adequate pressurization.

Then, release film R on which the micro lens L adheres passes the lower side of adhesive application roller 305. At this time, adhesive 72 is supplied from the upper side of the adhesive application roller 305, and supplied adhesive 72 is delivered to and adheres on the release film R after being applied on the external surface of adhesive application roller 305. At this time, it is preferable that a number of press rollers 306 pressurize release film R against adhesive application roller 305 and heating apparatus (not illustrated) heats to the film so that the adhesive 72 adheres on the side of release film R stably.

Then, release film R on which adhesive is applied as above-described passes with adhering on the lower side of ITO application roller 307. At this time, ITO resin is supplied from the upper position of ITO application roller 307 so that ITO layer 71 is applied on the side of release film R on which the adhesive 72 is applied. At this time, a number of press roller 308 pressurizes release film R against ITO application roller 307 in the lower side of ITO application roller 307, and UV hardening apparatus radiates UV to harden ITO resin at the same time.

When micro lens L, adhesive 72, and ITO layer 71 are formed on release film R in order, release film R is separated to separate from the film (hereinafter, ITO film) consisting of micro lens L-adhesive 72-ITO layer 71, and when the ITO film is pressurized to the side of substrate 3 of display device, ITO film adheres against the side of substrate 3 by the adhesive 72 stably.

In this example, it is preferable that the adhesive 72 consists of the resin having the higher reflective index of 1.5˜1.65 than that of micro lens L in order to increase efficiency of light extraction.

Meanwhile, in above-mentioned examples, optical/electronic structures with specified shapes are formed on the side of release film R while release film R passes formation roller. However, optical/electronic structures such as micro lens can be formed by the method of hardening after spraying liquefied resin on one side of release film besides, or silk printing method can be used by inserting resin for forming optical/electronic structures with a certain pressure inside cylinder-shaped screen where a number of minute holes are formed with uniform distance and by using the resin which is emitted through the holes to form optical/electronic structures on release film.

Except the above-described examples, the present invention can be applied in manufacturing a substrate or film for display device with a certain optical pattern or electric pattern on the surface, and can be applied in manufacturing Flexible Printed Circuit Board (FPCB) where circuit and/or connection pads are formed as electronic structure.

In the above, the present invention was described based on the specific preferred embodiments, but it should be apparent to those ordinarily skilled in the art that various changes and modifications can be added without departing from the spirit and scope of the present invention which will be defined in the appended claims.

1. A method of manufacturing a display device with optical/electronic structures comprising the steps of:
a first step for forming the optical/electronic structures on the primary side of a release film onto which an adhesive is attached;
a second step for attaching the primary side of the release film to a substrate or a film; and
a third step for removing only the release film from the substrate or the film while the optical/electronic structures are attached thereto.

2. The method of claim 1, wherein said first step is characterized that a resin is applied onto the primary side of a release film through a pattern groove by supplying the resin for forming the optical/electronic structures to a pattern roller, while the primary side of a release film passes with being pressed to an external side of the pattern roller which has the pattern corresponding with the optical/electronic structures.

3. The method of claim 1, wherein said first step is characterized to attach optical/electronic structures on a release film by spraying and hardening a resin for forming optical/electronic structures on the primary side of the release film.

4. The method of claim 1, wherein said first step is characterized to form optical/electronic structures on the primary side of a release film, which are hardened following that the optical/electronic structures fall upon the primary side of the release film to inject a resin for the optical/electronic structures inside a cylinder-typed screen in which a number of minute holes are formed at certain distances with a fixed pressure.

5. The method of claim 1, wherein said second step is characterized that when a release film is attached on a film, an adhesive having the higher refractive index than optical/electronic structures is applied on the primary side of a release film in advance, and the refractive index of the adhesive is 1.5 to 1.65.

6. The method of claim 1, wherein said optical/electronic structures having a form of hemisphere-shaped dome or polygon-shaped bump are a number of micro lenses altering the proceeding route of a light, and the refractive index of another adhesive being applied in the second step additionally is 1.5 to 1.65, which has the higher refractive index than micro lenses.

7. The method of claim 1, wherein said optical/electronic structures consist of black matrix and color filter.

8. The method of claim 7, further comprising the steps of:
a step of applying a protective film on the upper side in which color filter and black matrix are formed following the first step;
a step of applying an adhesive on the protective film; and
a step of applying a polarization film on the adhesive.

9. The method of claim 8, further comprising the step of:
a step of transferring the protective film, the adhesive, and the polarization film which is applied on another release film following the third step upon black matrix and color filter of the substrate.

10. The method of claim 7, wherein said first step comprises the steps of:
a step of supplying a resin for forming black matrix or color filter to a resin supply roller;
a step of delivering the resin to a pattern groove of a pattern formation roller which rotates and is connected with the resin supply roller, while the resin supply roller rotates;
a step of delivering the resin stored in the pattern groove to the external side of a blanket roller which rotates and is connected with the pattern formation roller, while the pattern formation roller rotates;
a step of hardening a pattered resin by radiating ultraviolet (UV) to the blanket roller; and
a step of forming black matrix and color filter to deliver the patterned resin to a side of the release film which passes between the blanket roller and a pressurization roller which rotates and is connected with the blanket roller, while the blanket roller rotates.

11. The method of claim 7, wherein said first step is characterized to supply the resin for forming black matrix or color filter to a formation roller having a pattern corresponding with the black matrix or the color filter; deliver the resin stored in the formation roller to the release film consecutively while the release film proceeds with adhered on the external side of the formation roller by passing the release film between a couple of pressurization rollers connected with the both side of the formation roller, and the external side of the formation roller; and form black matrix and color filter on the release film continuously.

12. The method of claim 7, wherein said second step is characterized to install the pressurization roller onto a side of the substrate which is connected with the pressurization roller and moves in one way horizontally, and be enable to pass the release film between the pressurization roller and the substrate to attach the black matrix and color filter applied on the release film to the substrate while the black matrix and color filter are pressurized by the pressurization roller.

13. The method of claim 7, further comprising the steps of:
a step of forming ITO layer on the rear side of the substrate; and
a step of forming an organic light emitting unit on the ITO layer.

14. The method of claim 13, wherein said step of forming an organic light emitting unit on the ITO layer is characterized to comprise the organic light emitting unit having 3 sub-pixels which emit the light with red, green and blue wavelength per each pixel respectively, or having a pixel which emits at least one white light per separate pixel.

15. The method of claim 1, wherein said first step consists of a step of attaching TFT on a side of the first release film, a step of attaching the second release film on the side which the TFT of the first release film is attached thereto, and a step of transferring the TFT on the second release film to be separated from the first release film;
said second step consists of a step of attaching the side of the second release film which the TFT is attached thereto upon the substrate; and
said third step consists of a step of separating only the second release film from the substrate while the TFT is transferred on the substrate.

16. The method of claim 15, wherein said step of attaching TFT on a side of the first release film is characterized to layer TFT structures with designed pattern in consecutive order while the first release film passes a number of printing rollers which supply different resins for TFT on the side of the printing rollers separately.

17. The method of claim 15, wherein said step of attaching the side of the second release film which the TFT is attached thereto upon the substrate is characterized that the second release film is pressurized against the substrate in a side of the substrate by using the pressurization roller to transfer the TFT on the substrate.

18. The method of claim 1, wherein said optical/electronic structures are characterized to be thin film layers, form the thin film layer on a side of the release film by using printing method in the first step, proceed the step sputtering ITO layer on the side of substrate or film following the first step, transfer the thin film layer of the release film on the ITO layer through the third step, and the thin film layer is an organic thin film layer forming organic light emitting diode (OLED) or polymer light emitting diode (PLED).

19. The method of claim 18, wherein said method is characterized to execute a heat or UV hardening process to increase an adhesive strength of interface among the separate thin film layers, and to transfer and layer thin film layers on the film consecutively while the films and release films pass a number of pressurization rollers rotating with constantly separated distance one another following the second step and the third step.

20. The method of claim 1, wherein said optical/electronic structures are characterized to be in-cell phase difference films;
the first step consists of a step of attaching the in-cell phase difference film on a side of the release film;
the second step consists of a step of attaching the side of the release film on which the in-cell phase difference film is attached upon the substrate or the color filter formed on the substrate; and
the third step consists of a step of separating only the second release film from the substrate while the in-cell phase difference film is transferred on the substrate or the color filter formed on the substrate.

21. The method of claim 20, further comprising a step of forming ITO layer on the in-cell phase difference film of the release film; and
wherein the first step is characterized to attach the in-cell phase difference film on the release film while the release film and the in-cell phase difference film pass through a number of rollers being contiguous each other at a time, and is pressurized.

22. The method of claim 1, wherein said optical/electronic structures are characterized to be light path conversion means;
the first step consists of a step of attaching the light path conversion means on the release film;
the second step consists of a step of attaching a polarization film on the side on which the light path conversion means of the release film are attached;
the third step consists of a step of attaching the polarization film and the light path conversion means on the substrate while the release film is separated from the complex of the polarization film and the release film; and
wherein the first step consists of a step of attaching at least one lens pattern on the release film, and a step of applying an adhesive on the side of the release film which the lens pattern is attached thereto.

23. The method of claim 22, wherein said step of attaching at least one lens pattern on the release film of the first step comprises the steps of:
a step of supplying a resin for forming lens pattern to a resin supply roller;
a step of delivering the resin for forming lens pattern to a pattern groove of a pattern formation roller which rotates and is connected with the resin supply roller, while the resin supply roller rotates;
a step of delivering the resin for forming lens pattern stored in the pattern groove to the external side of a blanket roller which rotates and is connected with the pattern formation roller, while the pattern formation roller rotates; and
a step of forming black matrix and color filter to deliver the patterned resin for forming lens pattern to a side of the release film which passes between the blanket roller and a pressurization roller which rotates and is connected with the blanket roller, while the blanket roller rotates.

24. The method of claim 22, wherein said step of attaching at least one lens pattern on the release film of the first step comprises the steps of:
a step of supplying a resin for forming lens pattern to a formation roller on which a number of patterns are formed with patterns corresponding with lens patterns;
a step of passing the release film with adhered on the external side of the formation roller;
a step of radiating UV while the release film is proceeded with adhered on the external side of the formation roller to harden the resin for forming lens pattern stored in the pattern groove of the formation roller, and
a step of separating the resin for forming lens pattern from the pattern groove and attaching the resin for forming lens pattern to the release film when the release film is separated from the formation roller.

25. The method of claim 22, wherein said first step comprises a step of applying the first adhesive layer as to form at least one lens pattern with bump-shaped on the release film, and a step of applying the second adhesive layer with the lower reflective index than the first adhesive layer among lens patterns of the first adhesive layer;
the said second step comprises a step of passing through at least one pressurization roller rotating with constantly separated distance between the release film and the polarization film to attach the release film and the polarization film each other; and
further comprising a step of executing a height compensation of the lens pattern in order to solve an optical fault of view.

26. A method of manufacturing a display device with optical/electronic structures comprising the steps of:
a first step for attaching optical/electronic structures on the primary side of a release film on which an adhesive is applied;
a second step for applying another adhesive on the primary side of the release film on which the optical/electronic structures are attached;
a third step for applying and hardening a resin for giving optical and electronic characteristics on the primary side of the release film to form a base film;
a fourth step for separating only the release film form the base film; and
a fifth step for attaching the base film upon the substrate or another film of display devices.

27. The method of claim 26, wherein said optical/electronic structures have a form of hemisphere-shaped dome or polygon-shaped bump, and are a number of micro lenses altering the proceeding route of a light; and
another adhesive of the second step is 1.5 to 1.65, which has the higher refractive index than the micro lenses.

28. The method of claim 8, further comprising the steps of:
a step of forming ITO layer on the rear side of the substrate; and
a step of forming an organic light emitting unit on the ITO layer.

29. The method of claim 9, further comprising the steps of:
a step of forming ITO layer on the rear side of the substrate; and
a step of forming an organic light emitting unit on the ITO layer.
